(19) United States
(12) Patent Application Publication
(10) Pub. No.: US 2025/0342569 A1
(43) Pub. Date: Nov. 6, 2025

(54) NEURAL-NETWORK POST-FILTER INPUT AND PROCESSING ORDER

(71) Applicants: Douyin Vision Co., Ltd., Beijing (CN); Bytedance Inc., Los Angeles, CA (US)

(72) Inventors: Ye-Kui Wang, San Diego, CA (US); Li Zhang, San Diego, CA (US); Chaoyi Lin, Beijing (CN); Yue Li, San Diego, CA (US); Junru Li, Beijing (CN); Jizheng Xu, San Diego, CA (US); Kai Zhang, San Diego, CA (US)

(21) Appl. No.: 19/268,243

(22) Filed: Jul. 14, 2025

Related U.S. Application Data
(63) Continuation of application No. PCT/CN2024/072224, filed on Jan. 15, 2024.

(30) Foreign Application Priority Data
Jan. 14, 2023 (WO) PCT/CN2023/072220

(51) Int. Cl. G06T 5/60; G06T 5/20; G06T 5/50; G06T 9/00

(52) U.S. Cl. CPC G06T 5/60; G06T 5/20; G06T 5/50; G06T 9/002; G06T 2207/10016; G06T 2207/20084

(57) ABSTRACT

A mechanism for processing video data is disclosed. The mechanism includes determining when an input of a neural-network post-filter (NNPF) activated for a current picture includes the current picture, the current picture used in the input is the current picture before applying the NNPF. A conversion is performed between a visual media data and a bitstream based on the NNPF.

### CROSS-REFERENCE TO RELATED PATENT APPLICATIONS

This patent application is a continuation of International Patent Application No. PCT/CN2024/072224 filed on Jan. 15, 2024, which claims the priority to and benefits of International Patent Application No. PCT/CN2023/072220 filed on Jan. 14, 2023. All the aforementioned patent applications are hereby incorporated by reference in their entireties.

### TECHNICAL FIELD

This patent document relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining when an input of a neural-network post-filter (NNPF) activated for a current picture includes the current picture, the current picture used in the input is the current picture before applying the NNPF; and performing a conversion between a visual media data and a bitstream based on the NNPF.

A second aspect relates to an apparatus for processing video data comprising: a processor; and a non-transitory memory with instructions thereon, wherein the instructions upon execution by the processor, cause the processor to perform any of the preceding aspects.

A third aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises: determining when an input of a neural-network post-filter (NNPF) activated for a current picture includes the current picture, the current picture used in the input is the current picture before applying the NNPF; and generating a bitstream based on the determining.

A fifth aspect relates to a method for storing bitstream of a video comprising: determining when an input of a neural-network post-filter (NNPF) activated for a current picture includes the current picture, the current picture used in the input is the current picture before applying the NNPF; generating a bitstream based on the determining; and storing the bitstream in a non-transitory computer-readable recording medium.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example of deriving luma channels from a luma component.

FIG. 2 is a block diagram showing an example video processing system.

FIG. 3 is a block diagram of an example video processing apparatus.

FIG. 4 is a flowchart for an example method of video processing.

FIG. 5 is a block diagram that illustrates an example video coding system.

FIG. 6 is a block diagram that illustrates an example encoder.

FIG. 7 is a block diagram that illustrates an example decoder.

FIG. 8 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present document for ease of understanding and do not limit the applicability of techniques and embodiments disclosed in each section only to that section. Furthermore, H.266 terminology is used in some description only for ease of understanding and not for limiting scope of the disclosed techniques. As such, the techniques described herein are applicable to other video codec protocols and designs also. In the present document, editing changes are shown to text by bold italics indicating cancelled text and bold indicating added text, with respect to the Versatile Video Coding (VVC) specification.

### 1. INITIAL DISCUSSION

This document is related to image/video coding technologies. Specifically, this disclosure is related to operations of neural-network post-filter (NNPF), including specification and signaling of the use of unfiltered or filtered picture(s) as input, specification and signaling of preferred processing order of different NNPFs, as well as signaling of whether an NNPF can be applied while decoding the pictures of the bitstream. The ideas may be applied individually or in various combinations, for video bitstreams coded by any codec, e.g., the versatile video coding (VVC) standard and/or the versatile supplemental enhancement information (SEI) messages for coded video bitstreams (VSEI) standard.

### 2. ABBREVIATIONS

adaptation parameter set (APS), access unit (AU), coded layer video sequence (CLVS), coded layer video sequence start (CLVSS), cyclic redundancy check (CRC), coded video sequence (CVS), finite impulse response (FIR), intra random access point (IRAP), network abstraction layer (NAL), picture parameter set (PPS), picture unit (PU), random access skipped leading (RASL) picture, supplemental enhancement information (SEI), step-wise temporal sublayer access (STSA), video coding layer (VCL), versatile supplemental enhancement information as described in Rec. ITU-T H.274|ISO/IEC 23002-7 (VSEI), video usability information (VUI), versatile video coding as described in Rec. ITU-T H.266|ISO/IEC 23090-3 (VVC).

### 3. FURTHER DISCUSSION

### 3.1 Video Coding Standards

Video coding standards have evolved primarily through the development of International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video and H.264/MPEG-4 Advanced Video Coding (AVC) and H.265/high efficiency video coding (HEVC) [1] standards. Since H.262, the video coding standards are based on the hybrid video coding structure wherein temporal prediction plus transform coding are utilized. To explore video coding technologies beyond high efficiency video coding (HEVC), the Joint Video Exploration Team (JVET) was founded by video coding experts group (VCEG) and motion picture experts group (MPEG). Further, methods have been adopted by JVET and put into the reference software named Joint Exploration Model (JEM) [2]. The JVET was later renamed to be the Joint Video Experts Team (JVET) when the Versatile Video Coding (VVC) project officially started. VVC [3] is a coding standard targeting at 50% bitrate reduction as compared to HEVC.

The Versatile Video Coding (VVC) standard (ITU-T H.266|ISO/IEC 23090-3) [3] and the associated Versatile Supplemental Enhancement Information for coded video bitstreams (VSEI) standard (ITU-T H.274|ISO/IEC 23002-7) [4] are designed for use in a maximally broad range of applications, including both the simple uses such as television broadcast, video conferencing, or playback from storage media, and also more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard under development by MPEG.

### 3.2 SEI Messages in General and in VVC and VSEI

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D of VVC specifies syntax and semantics for SEI message payloads for some SEI messages, and specifies the use of the SEI messages and VUI parameters for which the syntax and semantics are specified in ITU-T H.274|ISO/IEC 23002-7.

3.3 Signalling of neural-network post-filters

WG 05 output document N0158 [5] and JVET-AB2006 [6] include the specification of two SEI messages for signalling of neural-network post-filters, as follows.

### 8.28 Neural-Network Post-Filter Characteristics SEI Message

### 8.28.1 Neural-Network Post-Filter Characteristics SEI Message Syntax

| nn_post_filter_characteristics( payloadSize ) { | Descriptor |
|---|---|
| nnpfc_id | ue(v) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| nnpfc_formatting_and_purpose_flag | u(1) |
| if( nnpfc_formatting_and_purpose_flag ) { | |
| nnpfc_purpose | ue(v) |
| /* input and output formatting */ | |
| if( nnpfc_purpose = = 2 \| \| nnpfc_purpose = = 4 ) | |
| nnpfc_out_sub_c_flag | u(1) |
| else if( nnpfc_purpose = = 3 \| \| nnpfc_purpose = = 4 ) { | |
| nnpfc_pic_width_in_luma_samples | ue(v) |
| nnpfc_pic_height_in_luma_samples | ue(v) |
| } | |
| else if( nnpfc_purpose = = 5 ) { | |
| nnpfc_num_input_pics_minus2 | ue(v) |
| for( i = 0; i <= nnpfc_num_input_pics_minus2; i++ ) | |
| nnpfc_interpolated_pics[ i ] | ue(v) |
| } | |
| nnpfc_component_last_flag | u(1) |
| nnpfc_inp_format_idc | ue(v) |
| if( nnpfc_inp_format_idc = = 1 ) | |
| nnpfc_inp_tensor_bitdepth_minus8 | ue(v) |
| nnpfc_inp_order_idc | ue(v) |
| nnpfc_auxiliary_inp_idc | ue(v) |
| nnpfc_separate_colour_description_present_flag | u(1) |
| if( nnpfc_separate_colour_description_present_flag ) { | |
| nnpfc_colour_primaries | u(8) |
| nnpfc_transfer_characteristics | u(8) |
| nnpfc_matrix_coeffs | u(8) |
| } | |
| nnpfc_out_format_idc | ue(v) |
| if( nnpfc_out_format_idc = = 1 ) | |
| nnpfc_out_tensor_bitdepth_minus8 | ue(v) |
| nnpfc_out_order_idc | ue(v) |
| nnpfc_constant_patch_size_flag | u(1) |
| nnpfc_patch_width_minus1 | ue(v) |
| nnpfc_patch_height_minus1 | ue(v) |
| nnpfc_overlap | ue(v) |
| nnpfc_padding_type | ue(v) |
| if( nnpfc_padding_type = = 4 ) { | |
| nnpfc_luma_padding_val | ue(v) |
| nnpfc_cb_padding_val | ue(v) |
| nnpfc_cr_padding_val | ue(v) |
| } | |
| nnpfc_complexity_info_present_flag | ue(v) |
| if( nnpfc_complexity_info_present_flag ) { | |
| nnpfc_parameter_type_idc | u(2) |
| if( nnpfc_parameter_type_idc != 2 ) | |
| nnpfc_log2_parameter_bit_length_minus3 | u(2) |
| nnpfc_num_parameters_idc | u(6) |
| nnpfc_num_kmac_operations_idc | ue(v) |
| nnpfc_total_kilobyte_size | ue(v) |
| } | |
| } | |
| /* ISO/IEC 15938-17 bitstream */ | |
| if( nnpfc_mode_idc = = 0 ) { | |
| while( !byte_aligned( ) ) | |
| nnpfc_reserved_zero_bit_b | u(1) |
| for( i = 0; more_data_in_payload( ); i++ ) | |
| nnpfc_payload_byte[ i ] | b(8) |
| } | |
| } | |

### 8.28.2 Neural-Network Post-Filter Characteristics SEI Message Semantics

The neural-network post-filter characteristics (NNPFC) SEI message specifies a neural network that may be used as a post-processing filter. The use of specified post-processing filters for specific pictures is indicated with neural-network post-filter activation SEI messages.

Use of this SEI message requires the definition of the following variables:
Cropped decoded output picture width and height in units of luma samples, denoted herein by CroppedWidth and CroppedHeight, respectively.
Luma sample array CroppedYPic[idx] and chroma sample arrays CroppedCbPic[idx] and CroppedCrPic[idx], when present, of the cropped decoded output pictures with idx in the range of 0 to numInputPics−1, inclusive, that are used as input for the post-processing filter.
Bit depth BitDepthY for the luma sample array of the cropped decoded output pictures.
Bit depth BitDepthC for the chroma sample arrays, if any, of the cropped decoded output pictures.
A chroma format indicator, denoted herein by ChromaFormatIdc, as described in subclause 7.3.
When nnpfc_auxiliary_inp_idc is equal to 1, a filtering strength control value StrengthControlVal that shall be a real number in the range of 0 to 1, inclusive.

The variables SubWidthC and SubHeightC are derived from ChromaFormatIdc as specified by Table 2. NOTE 1—More than one NNPFC SEI message can be present for the same picture. When more than one NNPFC SEI message with different values of nnpfc_id is present or activated for the same picture, they can have the same or different values of nnpfc_purpose and nnpfc_mode_idc.

nnpfc_id contains an identifying number that may be used to identify a post-processing filter. The value of nnpfc_id shall be in the range of 0 to 232−2, inclusive. Values of nnpfc_id from 256 to 511, inclusive, and from 231 to 232−2, inclusive, are reserved for future use by ITU-T|ISO/IEC. Decoders conforming to this edition of this document encountering an NNPFC SEI message with nnpfc_id in the range of 256 to 511, inclusive, or in the range of 231 to 232−2, inclusive, shall ignore the SEI message.

When an NNPFC SEI message is the first NNPFC SEI message, in decoding order, that has a particular nnpfc_id value within the current CLVS, the following applies:
This SEI message specifies a base post-processing filter.
This SEI message pertains to the current decoded picture and all subsequent decoded pictures of the current layer, in output order, until the end of the current CLVS.

When an NNPFC SEI message is a repetition of a previous NNPFC SEI message, in decoding order, in the current CLVS, the subsequent semantics apply as if this SEI message were the only NNPFC SEI message having the same content within the current CLVS.

When an NNPFC SEI message is not the first NNPFC SEI message, in decoding order, that has a particular nnpfc_id value within the current CLVS, the following applies:
This SEI message defines an update relative to the preceding base post-processing filter in decoding order with the same nnpfc_id value.
This SEI message pertains to the current decoded picture and all subsequent decoded pictures of the current layer, in output order, until the end of the current CLVS or the next NNPFC SEI message having that particular nnpfc_id value, in output order, within the current CLVS.

nnpfc_mode_idc equal to 0 indicates that this SEI message contains an ISO/IEC 15938-17 bitstream that specifies a base post-processing filter or is an update relative to the base post-processing filter with the same nnpfc_id value.

When an NNPFC SEI message is the first NNPFC SEI message, in decoding order, that has a particular nnpfc_id value within the current CLVS, nnpfc_mode_idc equal to 1 specifies that the base post-processing filter associated with the nnpfc_id value is a neural network identified by the Uniform Resource Identifier (URI) indicated by nnpfc_uri with the format identified by the tag URI nnpfc_tag_uri.

When an NNPFC SEI message is not the first NNPFC SEI message, in decoding order, that has a particular nnpfc_id value within the current CLVS, nnpfc_mode_idc equal to 1 specifies that an update relative to the base post-processing filter with the same nnpfc_id value is defined by the URI indicated by nnpfc_uri with the format identified by the tag URI nnpfc_tag_uri.

The value of nnpfc_mode_idc shall be in the range of 0 to 1, inclusive, in bitstreams conforming to this edition of this document. Values of 2 to 255, inclusive, for nnpfc_mode_idc are reserved for future use by ITU-T|ISO/IEC and shall not be present in bitstreams conforming to this edition of this document. Decoders conforming to this edition of this document shall ignore NNPFC SEI messages with nnpfc_mode_idc in the range of 2 to 255, inclusive. Values of nnpfc_mode_idc greater than 255 shall not be present in bitstreams conforming to this edition of this document and are not reserved for future use.

When this SEI message is the first NNPFC SEI message, in decoding order, that has a particular nnpfc_id value within the current CLVS, the post-processing filter PostProcessingFilter( ) is assigned to be the same as the base post-processing filter.

When this SEI message is not the first NNPFC SEI message, in decoding order, that has a particular nnpfc_id value within the current CLVS, a post-processing filter PostProcessingFilter( ) is obtained by applying the update defined by this SEI message to the base post-processing filter.

Updates are not cumulative but rather each update is applied on the base post-processing filter, which is the post-processing filter specified by the first NNPFC SEI message, in decoding order, that has a particular nnpfc_id value within the current CLVS.

nnpfc_reserved_zero_bit_a shall be equal to 0 in bitstreams conforming to this edition of this document. Decoders shall ignore NNPFC SEI messages in which nnpfc_reserved_zero_bit_a is not equal to 0.

nnpfc_tag_uri contains a tag URI with syntax and semantics as specified in Internet Engineering Task Force (IETF) Request For Comment (RFC) 4151 identifying the format and associated information about the neural network used as a base post-processing filter or an update relative to the base post-processing filter with the same nnpfc_id value specified by nnpfc_uri.

NOTE 2—nnpfc_tag_uri enables uniquely identifying the format of neural network data specified by nnrpf_uri without needing a central registration authority.

nnpfc_tag_uri equal to “tag: iso.org,2023:15938-17” indicates that the neural network data identified by nnpfc_uri conforms to ISO/IEC 15938-17.

nnpfc_uri contains a URI with syntax and semantics as specified in IETF Internet Standard 66 identifying the neural network used as a base post-processing filter or an update relative to the base post-processing filter with the same nnpfc_id value.

nnpfc_formatting_and_purpose_flag equal to 1 specifies that syntax elements related to the filter purpose, input formatting, output formatting, and complexity are present. nnpfc_formatting_and_purpose_flag equal to 0 specifies that no syntax elements related to the filter purpose, input formatting, output formatting, and complexity are present.

When this SEI message is the first NNPFC SEI message, in decoding order, that has a particular nnpfc_id value within the current CLVS, nnpfc_formatting_and_purpose_flag shall be equal to 1. When this SEI message is not the first NNPFC SEI message, in decoding order, that has a particular nnpfc_id value within the current CLVS, nnpfc_formatting_and_purpose_flag shall be equal to 0.

nnpfc_purpose indicates the purpose of the post-processing filter as specified in Table 20.

The value of nnpfc_purpose shall be in the range of 0 to 5, inclusive, in bitstreams conforming to this edition of this document. Values of 6 to 1023, inclusive, for nnpfc_purpose are reserved for future use by ITU-T|ISO/IEC and shall not be present in bitstreams conforming to this edition of this document. Decoders conforming to this edition of this document shall ignore NNPFC SEI messages with nnpfc_purpose in the range of 6 to 1203, inclusive. Values of nnpfc_purpose greater than 1023 shall not be present in bitstreams conforming to this edition of this document and are not reserved for future use.

TABLE 20
Definition of nnpfc_purpose

| Value | Interpretation |
|---|---|
| 0 | May be used as determined by the application |
| 1 | Visual quality improvement |
| 2 | Chroma upsampling from the 4:2:0 chroma format to the 4:2:2 or 4:4:4 chroma format, or from the |
| | 4:2:2 chroma format to the 4:4:4 chroma format |
| 3 | Increasing the width or height of the cropped decoded output picture without changing the chroma |
| | format |
| 4 | Increasing the width or height of the cropped decoded output picture and upsampling the chroma |
| | format |
| 5 | Picture rate upsampling |

NOTE 3—When a reserved value of nnpfc_purpose is taken into use in the future by ITU-T|ISO/IEC, the syntax of this SEI message could be extended with syntax elements whose presence is conditioned by nnpfc_purpose being equal to that value.

When SubWidthC is equal to 1 and SubHeightC is equal to 1, nnpfc_purpose shall not be equal to 2 or 4.

nnpfc_out_sub_c_flag equal to 1 specifies that outSubWidthC is equal to 1 and outSubHeightC is equal to 1. nnpfc_out_sub_c_flag equal to 0 specifies that outSubWidthC is equal to 2 and outSubHeightC is equal to 1. When nnpfc_out_sub_c_flag is not present, outSubWidthC is inferred to be equal to SubWidthC and outSubHeightC is inferred to be equal to SubHeightC. When ChromaFormatIdc is equal to 2 and nnpfc_out_sub_c_flag is present, the value of nnpfc_out_sub_c_flag shall be equal to 1.

nnpfc_pic_width_in_luma_samples and nnpfc_pic_height_in_luma_samples specify the width and height, respectively, of the luma sample array of the picture resulting from applying the post-processing filter identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively. The value of nnpfc_pic_width_in_luma_samples shall be in the range of CroppedWidth to CroppedWidth*16-1, inclusive. The value of nnpfc_pic_height_in_luma_samples shall be in the range of CroppedHeight to CroppedHeight*16-1, inclusive.

nnpfc_num_input_pics_minus2 plus 2 specifies the number of decoded output pictures used as input for the post-processing filter.

nnpfc_interpolated_pics[i] specifies the number of interpolated pictures generated by the post-processing filter between the i-th and the (i+1)-th picture used as input for the post-processing filter.

The variables numInputPics, specifying the number of pictures used as input for the post-processing filter, and numOutputPics, specifying the total number of pictures resulting from the post-processing filter, are derived as follows:

```
if( nnpfc_purpose = = 5 ) {
        numInputPics = nnpfc_num_input_pics_minus2 + 2
        for( i = 0, numOutputPics = 0; i <= numInputPics − 2; i++ ) (76)
              numOutputPics += nnpfc_interpolated_pics[ i ]
} else
        numInputPics = 1
```

nnpfc_component_last_flag equal to 1 indicates that the last dimension in the input tensor inputTensor to the post-processing filter and the output tensor outputTensor resulting from the post-processing filter is used for a current channel. nnpfc_component_last_flag equal to 0 indicates that the third dimension in the input tensor inputTensor to the post-processing filter and the output tensor outputTensor resulting from the post-processing filter is used for a current channel.

NOTE 4—The first dimension in the input tensor and in the output tensor is used for the batch index, which is a practice in some neural network frameworks. While formulae in the semantics of this SEI message use the batch size corresponding to the batch index equal to 0, it is up to the post-processing implementation to determine the batch size used as input to the neural network inference.

NOTE 5—For example, when nnpfc_inp_order_idc is equal to 3 and nnpfc_auxiliary_inp_idc is equal to 1, there are 7 channels in the input tensor, including four luma matrices, two chroma matrices, and one auxiliary input matrix. In this case, the process DeriveInputTensors( ) would derive each of these 7 channels of the input tensor one by one, and when a particular channel of these channels is processed, that channel is referred to as the current channel during the process.

nnpfc_inp_format_idc indicates the method of converting a sample value of the cropped decoded output picture to an input value to the post-processing filter. When nnpfc_inp_format_idc is equal to 0, the input values to the post-processing filter are real numbers and the functions InpY( ) and InpC( ) are specified as follows:

| | |
|---|---|
| InpY( x ) = x ÷ ( ( 1 << BitDepthY ) − 1 ) | (77) |
| InpC( x )= x ÷ ( ( 1 << BitDepthC ) − 1 ) | (78) |

When nnpfc_inp_format_idc is equal to 1, the input values to the post-processing filter are unsigned integer numbers and the functions InpY( ) and InpC( ) are specified as follows:

| shiftY = BitDepth Y − inpTensorBitDepth | |
|---|---|
| if( inpTensorBitDepth >= BitDepthY) | |
| InpY( x ) = x << ( inpTensorBitDepth − BitDepthY ) | (79) |
| else | |
| InpY( x ) = Clip3(0, ( 1 << inpTensorBitDepth) − 1, ( x + ( 1 << (shiftY − 1 ) ) ) >> shiftY ) | |
| shiftC = BitDepthC − inpTensorBitDepth | |
| if( inpTensorBitDepth >= BitDepthC ) | |
| InpC( x ) = x << ( inpTensorBitDepth − BitDepthC ) | (80) |
| else | |

InpC( x ) = Clip3(0, ( 1 << inpTensorBitDepth ) − 1, ( x + ( 1 << ( shiftC − 1 ) ) ) >> shiftC )

The variable inpTensorBitDepth is derived from the syntax element nnpfc_inp_tensor_bitdepth_minus8 as specified below.

Values of nnpfc_inp_format_idc greater than 1 are reserved for future specification by ITU-T|ISO/IEC and shall not be present in bitstreams conforming to this edition of this document. Decoders conforming to this edition of this document shall ignore NNPFC SEI messages that contain reserved values of nnpfc_inp_format_idc.

nnpfc_inp_tensor_bitdepth_minus8 plus 8 specifies the bit depth of luma sample values in the input integer tensor. The value of inpTensorBitDepth is derived as follows:

$$inpTensorBitDepth = nnpfc\_inp \_tensor \_bitdepth \_minus8 + 8 \qquad ( 81 )$$

It is a requirement of bitstream conformance that the value of nnpfc_inp_tensor_bitdepth_minus8 shall be in the range of 0 to 24, inclusive.

nnpfc_inp_order_idc indicates the method of ordering the sample arrays of a cropped decoded output picture as one of the input pictures to the post-processing filter.

The value of nnpfc_inp_order_idc shall be in the range of 0 to 3, inclusive, in bitstreams conforming to this edition of this document. Values of 4 to 255, inclusive, for nnpfc_inp_order_idc are reserved for future use by ITU-T|ISO/IEC and shall not be present in bitstreams conforming to this edition of this document. Decoders conforming to this edition of this document shall ignore NNPFC SEI messages with nnpfc_inp_order_idc in the range of 4 to 255, inclusive. Values of nnpfc_inp_order_idc greater than 255 shall not be present in bitstreams conforming to this edition of this document and are not reserved for future use.

When ChromaFormatIdc is not equal to 1, nnpfc_inp_order_idc shall not be equal to 3.

Table 21 contains an informative description of nnpfc_inp_order_idc values.

TABLE 21
Description of nnpfc_inp_order_idc values

| nnpfc_inp_ | |
|---|---|
| order_idc | Description |
| 0 | If nnpfc_auxiliary_inp_idc is equal to 0, one luma matrix is present in the input tensor for |
| | each input picture, and the number of channels is 1. Otherwise when |
| | nnpfc_auxiliary_inp_idc is equal to 1, one luma matrix and one auxiliary input matrix are |
| | present, and the number of channels is 2. |
| 1 | If nnpfc_auxiliary_inp_idc is equal to 0, two chroma matrices are present in the input tensor, |
| | and the number of channels is 2. Otherwise when nnpfc_auxiliary_inp_idc is equal to 1, two |
| | chroma matrices and one auxiliary input matrix are present, and the number of channels is |
| | 3. |
| 2 | If nnpfc_auxiliary_inp_idc is equal to 0, one luma and two chroma matrices are present in |
| | the input tensor, and the number of channels is 3. Otherwise when nnpfc_auxiliary_inp_idc |
| | is equal to 1, one luma matrix, two chroma matrices and one auxiliary input matrix are |
| | present, and the number of channels is 4. |
| 3 | If nnpfc_auxiliary_inp_idc is equal to 0, four luma matrices and two chroma matrices are |
| | present in the input tensor, and the number of channels is 6. Otherwise when |
| | nnpfc_auxiliary_inp_idc is equal to 1, four luma matrices, two chroma matrices, and one |
| | auxiliary input matrix are present in the input tensor, and the number of channels is 7. The |
| | luma channels are derived in an interleaved manner as illustrated in Figure 12. This |
| | nnpfc_inp_order_idc can only be used when the chroma format is 4:2:0. |
| 4..255 | Reserved |

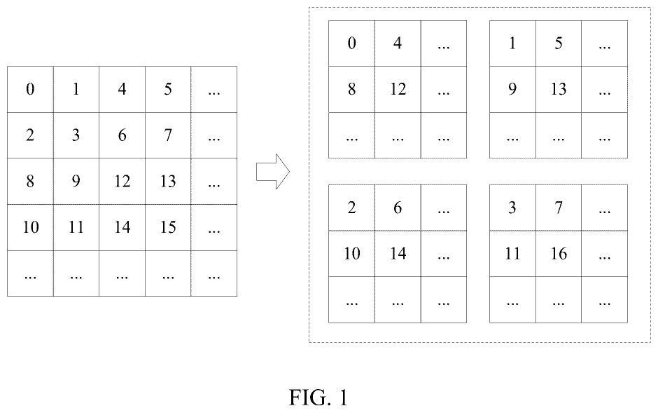

FIG. 1 illustrates an example of deriving luma channels from a luma component, for example when nnpfc_inp_order_idc is equal to 3.

A patch is a rectangular array of samples from a component (e.g., a luma or chroma component) of a picture.

nnpfc_auxiliary_inp_idc greater than 0 indicates that auxiliary input data is present in the input tensor of the neural-network post-filter. nnpfc_auxiliary_inp_idc equal to 0 indicates that auxiliary input data is not present in the input tensor. nnpfc_auxiliary_inp_idc equal to 1 specifies that auxiliary input data is derived as specified in Formula 82.

The value of nnpfc_auxiliary_inp_idc shall be in the range of 0 to 1, inclusive, in bitstreams conforming to this edition of this document. Values of 2 to 255, inclusive, for nnpfc_inp_order_idc are reserved for future use by ITU-T|ISO/IEC and shall not be present in bitstreams conforming to this edition of this document. Decoders conforming to this edition of this document shall ignore NNPFC SEI messages with nnpfc_inp_order_idc in the range of 2 to 255, inclusive. Values of nnpfc_inp_order_idc greater than 255 shall not be present in bitstreams conforming to this edition of this document and are not reserved for future use.

The process DeriveInputTensors( ) for deriving the input tensor inputTensor for a given vertical sample coordinate cTop and a horizontal sample coordinate cLeft specifying the top-left sample location for the patch of samples included in the input tensor, is specified as follows:

```
for( i = 0; i < numInputPics; i++ ) {
        if( nnpfc_inp_order_idc = = 0 )
              for( yP = −overlapSize; yP < inpPatchHeight + overlapSize; yP++)
                for( xP = −overlapSize; xP < inpPatchWidth + overlapSize; xP++ ) {
                    inpVal = InpY( InpSampleVal( cTop + yP, cLeft + xP, CroppedHeight,
                                  CroppedWidth, CroppedYPic[ i ] ) )
                    if( !nnpfc_component_last_flag )
                        inputTensor[ 0 ][ i ][ 0 ][ yP + overlapSize ][ xP + overlapSize ] = inpVal
                    else
                        inputTensor[ 0 ][ i ][ yP + overlapSize ][ xP + overlapSize ][ 0 ] = inpVal
                    if( nnpfc_auxiliary_inp_idc = = 1 )
                        if( !nnpfc_component_last_flag )
                        inputTensor[ 0 ][ i ][ 1 ][ yP + overlapSize ][ xP + overlapSize ] =
StrengthControlVal
                        else
                        inputTensor[ 0 ][ i ][ yP + overlapSize ][ xP + overlapSize ][ 1 ] =
StrengthControlVal
                }
        else if( nnpfc_inp_order_idc = = 1 ) (82)
              for( yP = −overlapSize; yP < inpPatchHeight + overlapSize; yP++)
                for( xP = −overlapSize; xP < inpPatchWidth + overlapSize; xP++ ) {
                  inpCbVal = InpC( InpSampleVal( cTop + yP, cLeft + xP, CroppedHeight /
SubHeightC,
                        CroppedWidth / SubWidthC, CroppedCbPic[ i ] ) )
                  inpCrVal = InpC( InpSampleVal( cTop + yP, cLeft + xP, CroppedHeight /
SubHeightC,
                        CroppedWidth / SubWidthC, CroppedCrPic[ i ] ) )
                  if( !nnpfc_component_last_flag ) {
                      inputTensor[ 0 ][ i ][ 0 ][ yP + overlapSize ][ xP + overlapSize ] = inpCbVal
                      inputTensor[ 0 ][ i ][ 1 ][ yP + overlapSize ][ xP + overlapSize ] = inpCrVal
                  } else {
                      inputTensor[ 0 ][ i ][ yP + overlapSize ][ xP + overlapSize ][ 0 ] = inpCbVal
                      inputTensor[ 0 ][ i ][ yP + overlapSize ][ xP + overlapSize ][ 1 ] = inpCrVal
                  }
                  if( nnpfc_auxiliary_inp_idc = = 1 )
                      if( !nnpfc_component_last_flag )
                      inputTensor[ 0 ][ i ][ 2 ][ yP + overlapSize ][ xP + overlapSize ] =
StrengthControlVal
                      else
                      inputTensor[ 0 ][ i ][ yP + overlapSize ][ xP + overlapSize ][ 2 ] =
StrengthControlVal
                }
        else if( nnpfc_inp_order_idc = = 2 )
              for( yP = −overlapSize; yP < inpPatchHeight + overlapSize; yP++)
                for( xP = −overlapSize; xP < inpPatchWidth + overlapSize; xP++ ) {
                    yY = cTop + yP
                    xY = cLeft + xP
                    yC = yY / SubHeightC
                    xC = xY / SubWidthC
                    inp YVal = InpY( InpSampleVal( yY, xY, CroppedHeight,
                                  CroppedWidth, CroppedYPic[ i ] ) )
                    inpCbVal = InpC( InpSampleVal( yC, xC, CroppedHeight / SubHeightC,
                            CroppedWidth / SubWidthC, CroppedCbPic[ i ] ) )
                    inpCrVal = InpC( InpSampleVal( yC, xC, CroppedHeight / SubHeightC,
                            CroppedWidth / SubWidthC, CroppedCrPic[ i ] ) )
                    if( !nnpfc_component_last_flag ) {
                        inputTensor[ 0 ][ i ][ 0 ][ yP + overlapSize ][ xP + overlapSize ] = inpYVal
                        inputTensor[ 0 ][ i ][ 1 ][ yP + overlapSize ][ xP + overlapSize ] = inpCbVal
                        inputTensor[ 0 ][ i ][ 2 ][ yP + overlapSize ][ xP + overlapSize ] = inpCrVal
                    } else {
                        inputTensor[ 0 ][ i ][ yP + overlapSize ][ xP + overlapSize ][ 0 ] = inpYVal
                        inputTensor[ 0 ][ i ][ yP + overlapSize ][ xP + overlapSize ][ 1 ] = inpCbVal
                        inputTensor[ 0 ][ i ][ yP + overlapSize ][ xP + overlapSize ][ 2 ] = inpCrVal
                    }
                    if( nnpfc_auxiliary_inp_idc = = 1 )
                        if( !nnpfc_component_last_flag )
                        inputTensor[ 0 ][ i ][ 3 ][ yP + overlapSize ][ xP + overlapSize ] =
StrengthControlVal
                        else
                        inputTensor[ 0 ][ i ][ yP + overlapSize ][ xP + overlapSize ][ 3 ] =
StrengthControlVal
                }
        else if( nnpfc_inp_order_idc = = 3 )
            for( yP = −overlapSize; yP < inpPatchHeight + overlapSize; yP++)
              for( xP = −overlapSize; xP < inpPatchWidth + overlapSize; xP++ ) {
                  yTL = cTop + yP * 2
                  xTL = cLeft + xP * 2
                  yBR = yTL + 1
                  xBR = xTL + 1
                  yC = cTop / 2 + yP
                  xC = cLeft / 2 + xP
                  inpTLVal = InpY( InpSampleVal( yTL, xTL, CroppedHeight,
                                CroppedWidth, CroppedYPic[ i ] ) )
                  inpTRVal = InpY( InpSampleVal( yTL, xBR, CroppedHeight,
                                CroppedWidth, CroppedYPic[ i ] ) )
                  inpBLVal = InpY( InpSampleVal( yBR, xTL, CroppedHeight,
                                CroppedWidth, CroppedYPic[ i] ) )
                  inpBRVal = InpY( InpSampleVal( yBR, xBR, CroppedHeight,
                                CroppedWidth, CroppedYPic[ i ] ) )
                  inpCbVal = InpC( InpSampleVal( yC, xC, CroppedHeight / 2,
                              CroppedWidth / 2, CroppedCbPic[ i ] ) )
                  inpCrVal = InpC( InpSampleVal( yC, xC, CroppedHeight / 2,
                              CroppedWidth / 2, CroppedCrPic[ i ] ) )
                  if( Innpfc_component_last_flag ) {
                      inputTensor[ 0 ][ i ][ 0 ][ yP + overlapSize ][ xP + overlapSize ] = inpTLVal
                      inputTensor[ 0 ][ i ][ 1 ][ yP + overlapSize ][ xP + overlapSize ] = inpTRVal
                      inputTensor[ 0 ][ i ][ 2 ][ yP + overlapSize ][ xP + overlapSize ] = inpBLVal
                      inputTensor[ 0 ][ i ][ 3 ][ yP + overlapSize ][ xP + overlapSize ] = inpBRVal
                      inputTensor[ 0 ][ i ][ 4 ][ yP + overlapSize ][ xP + overlapSize ] = inpCbVal
                      inputTensor[ 0 ][ i ][ 5 ][ yP + overlapSize ][ xP + overlapSize ] = inpCrVal
                  } else {
                      inputTensor[ 0 ][ i ][ yP + overlapSize ][ xP + overlapSize ][ 0 ] = inpTLVal
                      inputTensor[ 0 ][ i ][ yP + overlapSize ][ xP + overlapSize ][ 1 ] = inpTRVal
                      inputTensor[ 0 ][ i ][ yP + overlapSize ][ xP + overlapSize ][ 2 ] = inpBLVal
                      inputTensor[ 0 ][ i ][ yP + overlapSize ][ xP + overlapSize ][ 3 ] = inpBRVal
                      inputTensor[ 0 ][ i ][ yP + overlapSize ][ xP + overlapSize ][ 4 ] = inpCbVal
                      inputTensor[ 0 ][ i ][ yP + overlapSize ][ xP + overlapSize ][ 5 ] = inpCrVal
                  }
                  if( nnpfc_auxiliary_inp_idc = = 1 )
                      if( !nnpfc_component_last_flag )
                      inputTensor[ 0 ][ i ][ 6 ][ yP + overlapSize ][ xP + overlapSize ] =
StrengthControlVal
                      else
                      inputTensor[ 0 ][ i ][ yP + overlapSize ][ xP + overlapSize ][ 6 ] =
StrengthControlVal
                }
}
```

nnpfc_separate_colour_description_present_flag equal to 1 indicates that a distinct combination of colour primaries, transfer characteristics, and matrix coefficients for the picture resulting from the post-processing filter is specified in the SEI message syntax structure. nnfpc_separate_colour_description_present_flag equal to 0 indicates that the combination of colour primaries, transfer characteristics, and matrix coefficients for the picture resulting from the post-processing filter is the same as indicated in VUI parameters for the CLVS.

nnpfc_colour_primaries has the same semantics as specified in subclause 7.3 for the vui_colour_primaries syntax element, except as follows:
nnpfc_colour_primaries specifies the colour primaries of the picture resulting from applying the neural-network post-filter specified in the SEI message, rather than the colour primaries used for the CLVS.
When nnpfc_colour_primaries is not present in the NNPFC SEI message, the value of nnpfc_colour_primaries is inferred to be equal to vui_colour_primaries.

nnpfc_transfer_characteristics has the same semantics as specified in subclause 7.3 for the vui_transfer_characteristics syntax element, except as follows:
nnpfc_transfer_characteristics specifies the transfer characteristics of the picture resulting from applying the neural-network post-filter specified in the SEI message, rather than the transfer characteristics used for the CLVS.
When nnpfc_transfer_characteristics is not present in the NNPFC SEI message, the value of nnpfc_transfer_characteristics is inferred to be equal to vui_transfer_characteristics.

nnpfc_matrix_coeffs has the same semantics as specified in subclause 7.3 for the vui_matrix_coeffs syntax element, except as follows:
nnpfc_matrix_coeffs specifies the matrix coefficients of the picture resulting from applying the neural-network post-filter specified in the SEI message, rather than the matrix coefficients used for the CLVS.
When nnpfc_matrix_coeffs is not present in the NNPFC SEI message, the value of nnpfc_matrix_coeffs is inferred to be equal to vui_matrix_coeffs.
The values allowed for nnpfc_matrix_coeffs are not constrained by the chroma format of the decoded video pictures that is indicated by the value of ChromaFormatIdc for the semantics of the VUI parameters.
When nnpfc_matrix_coeffs is equal to 0, nnpfc_out_order_idc shall not be equal to 1 or 3.

nnpfc_out_format_idc equal to 0 indicates that the sample values output by the post-processing filter are real numbers where the value range of 0 to 1, inclusive, maps linearly to the unsigned integer value range of 0 to (1<<bitDepth)−1, inclusive, for any desired bit depth bitDepth for subsequent post-processing or displaying.

nnpfc_out_format_flag equal to 1 indicates that the sample values output by the post-processing filter are unsigned integer numbers in the range of 0 to (1<<(nnpfc_out_tensor_bitdepth_minus8+8))−1, inclusive.

Values of nnpfc_out_format_idc greater than 1 are reserved for future specification by ITU-T|ISO/IEC and shall not be present in bitstreams conforming to this edition of this document. Decoders conforming to this edition of this document shall ignore NNPFC SEI messages that contain reserved values of nnpfc_out_format_idc.

nnpfc_out_tensor_bitdepth_minus8 plus 8 specifies the bit depth of sample values in the output integer tensor. The value of nnpfc_out_tensor_bitdepth_minus8 shall be in the range of 0 to 24, inclusive.

nnpfc_out_order_idc indicates the output order of samples resulting from the post-processing filter.

The value of nnpfc_out_order_idc shall be in the range of 0 to 3, inclusive, in bitstreams conforming to this edition of this document. Values of 4 to 255, inclusive, for nnpfc_out_order_idc are reserved for future use by ITU-T|ISO/IEC and shall not be present in bitstreams conforming to this edition of this document. Decoders conforming to this edition of this document shall ignore NNPFC SEI messages with nnpfc_out_order_idc in the range of 4 to 255, inclusive. Values of nnpfc_out_order_idc greater than 255 shall not be present in bitstreams conforming to this edition of this document and are not reserved for future use.

When nnpfc_purpose is equal to 2 or 4, nnpfc_out_order_idc shall not be equal to 3.

Table 22 contains an informative description of nnpfc_out_order_idc values.

TABLE 22
Description of nnpfc_out_order_idc values

| nnpfc_out | |
|---|---|
| order_idc | Description |
| 0 | Only the luma matrix is present in the output tensor, thus the number of channels is 1. |
| 1 | Only the chroma matrices are present in the output tensor, thus the number of channels is 2. |
| 2 | The luma and chroma matrices are present in the output tensor, thus the number of channels is 3. |
| 3 | Four luma matrices and two chroma matrices are present in the output tensor, thus the number |
| | of channels is 6. This nnpfc_out_order_idc can only be used when the chroma format is 4:2:0. |
| 4..255 | Reserved |

The process StoreOutputTensors( ), for deriving sample values in the filtered output sample arrays FilteredYPic, FilteredCbPic, and FilteredCrPic from the output tensor outputTensor for a given vertical sample coordinate cTop and a horizontal sample coordinate cLeft specifying the top-left sample location for the patch of samples included in the input tensor, is specified as follows:

```
for( i = 0; i < numInputPics; i++ ) {
        if( nnpfc_out_order_idc = = 0 )
              for( yP = 0; yP < outPatchHeight; yP++)
                for( xP = 0; xP < outPatchWidth; xP++ ) {
                    yY = cTop * outPatchHeight / inpPatchHeight + yP
                    xY = cLeft * outPatchWidth / inpPatchWidth + xP
                    if ( yY < nnpfc_pic_height_in_luma_samples && xY <
nnpfc_pic_width_in_luma_samples )
                        if( !nnpfc_component_last_flag )
                        FilteredYPic[ i ][ xY ][yY ] = outputTensor[ 0 ][ i ][ 0 ][ yP ][ xP ]
                        else
                        FilteredYPic[ i ][ xY ][ yY ] = outputTensor[ 0 ][ i ][ yP ][ xP ][ 0 ]
                }
          else if( nnpfc_out_order_idc = = 1 ) (83)
              for( yP = 0; yP < outPatchCHeight; yP++)
                for( xP = 0; xP < outPatchCWidth; xP++ ) {
                    xSrc = cLeft * horCScaling + xP
                    ySrc = cTop * verCScaling + yP
                    if ( ySrc < nnpfc_pic_height_in_luma_samples / outSubHeightC &&
                        xSrc < nnpfc_pic_width_in_luma_samples / outSubWidthC )
                        if( !nnpfc_component_last_flag ) {
                        FilteredCbPic[ i ][ xSrc ][ ySrc ] = outputTensor[ 0 ][ i ][ 0 ][ yP ][ xP ]
                        FilteredCrPic[ i ][ xSrc ][ ySrc ] = outputTensor[ 0 ][ i ][ 1 ][ yP ][ xP ]
                        } else {
                        FilteredCbPic[ i ][ xSrc ][ ySrc ] = outputTensor[ 0 ][ i ][ yP ][ xP ][ 0 ]
                        FilteredCrPic[ i ][ xSrc ][ ySrc ] = outputTensor[ 0 ][ i ][ yP ][ xP ][ 1 ]
                        }
                }
          else if( nnpfc_out_order_idc = = 2 )
              for( yP = 0; yP < outPatchHeight; yP++)
                for( xP = 0; xP < outPatchWidth; xP++ ) {
                    yY = cTop * outPatchHeight / inpPatchHeight + yP
                    xY = cLeft * outPatchWidth / inpPatchWidth + xP
                    yC = yY / outSubHeightC
                    xC = xY / outSubWidthC
                    yPc =(yP / outSubHeightC ) * outSubHeightC
                    xPc = (xP / outSubWidthC ) * outSubWidthC
                    if ( yY < nnpfc_pic_height_in_luma_samples && xY <
nnpfc_pic_width_in_luma_samples)
                        if( !nnpfc_component_last_flag ) {
                        FilteredYPic[ i ][ xY ][ yY ] = outputTensor[ 0 ][ i ][ 0 ][ yP ][ xP ]
                        FilteredCbPic[ i ][ xC ][ yC ] = outputTensor[ 0 ][ i ][ 1 ][ yPc ][ xPc ]
                        FilteredCrPic[ i ][ xC ][ yC ] = outputTensor[ 0 ][ i ][ 2 ][ yPc ][ xPc ]
                        } else {
                        FilteredYPic[ i ][ xY ][ yY ] = outputTensor[ 0 ][ i ][ yP ][ xP ][ 0 ]
                        FilteredCbPic[ i ][ xC ][ yC ] = outputTensor[ 0 ][ i ][ yPc ][ xPc ][ 1 ]
                        FilteredCrPic[ i ][ xC ][ yC ] = outputTensor[ 0 ][ i ][ yPc ][ xPc ][ 2 ]
                        }
                }
          else if( nnpfc_out_order_idc = = 3 )
              for( yP = 0; yP < outPatchHeight; yP++ )
                for( xP = 0; xP < outPatchWidth; xP++ ) {
                    ySrc = cTop / 2 * outPatchHeight / inpPatchHeight + yP
                    xSrc = cLeft / 2 * outPatchWidth / inpPatchWidth + xP
                    if ( ySrc < nnpfc_pic_height_in_luma_samples / 2 &&
                            xSrc < nnpfc_pic_width_in_luma_samples / 2 )
                        if( !nnpfc_component_last_flag ) {
                        FilteredYPic[ i ][ xSrc * 2 ][ ySrc * 2 ] = outputTensor[ 0 ][ i ][ 0 ][ yP ][ xP ]
                        FilteredYPic[ i ][ xSrc * 2 + 1 ][ ySrc * 2 ] = outputTensor[ 0 ][ i ][ 1 ][ yP ][ xP ]
                        FilteredYPic[ i ][ xSrc * 2 ][ ySrc * 2 + 1 ] = outputTensor[ 0 ][ i ][ 2 ][ yP ][ xP ]
                            FilteredYPic[ i ][ xSrc * 2 + 1][ ySrc * 2 + 1 ] =
outputTensor[ 0 ][ i ][ 3 ][ yP ][ xP ]
                        FilteredCbPic[ i ][ xSrc ][ ySrc ] = outputTensor[ 0 ][ i ][ 4 ][ yP ][ xP ]
                        FilteredCrPic[ i ][ xSrc ][ ySrc ] = outputTensor[ 0 ][ i ][ 5 ][ yP ][ xP ]
                        } else {
                        FilteredYPic[ i ][ xSrc * 2 ][ ySrc * 2 ] = outputTensor[ 0 ][ i ][ yP ][ xP ][ 0 ]
                        FilteredYPic[ i ][ xSrc * 2 + 1 ][ ySrc * 2 ] = outputTensor[ 0 ][ i ][ yP ][ xP ][ 1 ]
                        FilteredYPic[ i ][ xSrc * 2 ][ ySrc * 2 + 1 ] = outputTensor[ 0 ][ i ][ yP ][ xP ][ 2 ]
                            FilteredYPic[ i ][ xSrc * 2 + 1][ ySrc * 2 + 1 ] =
outputTensor[ 0 ][ i ][ yP ][ xP ][ 3 ]
                        FilteredCbPic[ i ][ xSrc ][ ySrc ] = outputTensor[ 0 ][ i ][ yP ][ xP ][ 4 ]
                        FilteredCrPic[ i ][ xSrc ][ ySrc ] = outputTensor[ 0 ][ i ][ yP ][ xP ][ 5 ]
                        }
                  }
}
```

nnpfc_constant_patch_size_flag equal to 1 indicates that the post-processing filter accepts exactly the patch size indicated by nnpfc_patch_width_minus1 and nnpfc_patch_height_minus1 as input. nnpfc_constant_patch_size_flag equal to 0 indicates that the post-processing filter accepts any patch size that is a positive integer multiple of the patch size indicated by nnpfc_patch_width_minus1 and nnpfc_patch_height_minus1 as input.

nnpfc_patch_width_minus1+1, when nnpfc_constant_patch_size_flag equal to 1, indicates the horizontal sample counts of the patch size required for the input to the post-processing filter. The value of nnpfc_patch_width_minus1 shall be in the range of 0 to Min (32766, CroppedWidth-1), inclusive.

nnpfc_patch_height_minus1+1, when nnpfc_constant_patch_size_flag equal to 1, indicates the vertical sample counts of the patch size required for the input to the post-processing filter. The value of nnpfc_patch_height_minus1 shall be in the range of 0 to Min (32766, CroppedHeight-1), inclusive.

Let the variables inpPatchWidth and inpPatchHeight be the patch size width and the patch size height, respectively.

If nnpfc_constant_patch_size_flag is equal to 0, the following applies:
The values of inpPatchWidth and inpPatchHeight are either provided by external means not specified in this document or set by the post-processor itself.
The value of inpPatchWidth shall be a positive integer multiple of nnpfc_patch_width_minus1+1 and shall be less than or equal to CroppedWidth. The value of inpPatchHeight shall be a positive integer multiple of nnpfc_patch_height_minus1+1 and shall be less than or equal to CroppedHeight.

Otherwise (nnpfc_constant_patch_size_flag is equal to 1), the value of inpPatchWidth is set equal to nnpfc_patch_width_minus1+1 and the value of inpPatchHeight is set equal to nnpfc_patch_height_minus1+1.

nnpfc_overlap indicates the overlapping horizontal and vertical sample counts of adjacent input tensors of the post-processing filter. The value of nnpfc_overlap shall be in the range of 0 to 16383, inclusive.

The variables outPatchWidth, outPatchHeight, horCScaling, verCScaling, outPatchCWidth, outPatchCHeight, and overlapSize are derived as follows:

| | |
|---|---|
| outPatchWidth = ( nnpfc_pic_width_in_luma_samples * inpPatchWidth ) / CroppedWidth | (84) |
| outPatchHeight = ( nnpfc_pic_height_in_luma_samples * inpPatchHeight ) / CroppedHeight | (85) |
| horCScaling = SubWidthC / outSubWidthC | (86) |
| verCScaling = SubHeightC / outSubHeightC | (87) |
| outPatchCWidth = outPatchWidth * horCScaling | (88) |
| outPatchCHeight = outPatchHeight * verCScaling | (89) |
| overlapSize = nnpfc_overlap | (90) |

It is a requirement of bitstream conformance that outPatchWidth*CroppedWidth shall be equal to nnpfc_pic_width_in_luma_samples*inpPatchWidth and outPatchHeight*CroppedHeight shall be equal to nnpfc_pic_height_in_luma_samples*inpPatchHeight.

nnpfc_padding_type indicates the process of padding when referencing sample locations outside the boundaries of the cropped decoded output picture as described in Table 23. The value of nnpfc_padding_type shall be in the range of 0 to 15, inclusive.

TABLE 23
Informative description of nnpfc_padding_type values

| nnpfc_padding_type | Description |
|---|---|
| 0 | zero padding |
| 1 | replication padding |
| 2 | reflection padding |
| 3 | wrap-around padding |
| 4 | fixed padding |
| 5..15 | Reserved |

nnpfc_luma_padding_val indicates the luma value to be used for padding when nnpfc_padding_type is equal to 4.

nnpfc_cb_padding_val indicates the Cb value to be used for padding when nnpfc_padding_type is equal to 4.

nnpfc_cr_padding_val indicates the Cr value to be used for padding when nnpfc_padding_type is equal to 4.

The function InpSampleVal(y, x, picHeight, picWidth, croppedPic) with inputs being a vertical sample location y, a horizontal sample location x, a picture height picHeight, a picture width picWidth, and sample array croppedPic returns the value of sampleVal derived as follows:

NOTE 6—For the inputs to the function InpSampleVal( ), the vertical location is listed before the horizontal location for compatibility with input tensor conventions of some inference engines.

```
if( nnpfc_padding_type = = 0 )
        if( y < 0 | | x <0 | | y >= picHeight | | x >= picWidth )
              sampleVal = 0
        else
              sampleVal = croppedPic[ x ][ y ] (91)
else if( nnpfc_padding_type = = 1 )
        sampleVal = croppedPic[ Clip3( 0, picWidth − 1, x) ][ Clip3( 0, picHeight − 1, y ) ]
else if( nnpfc_padding_type = = 2 )
        sampleVal = croppedPic[ Reflect( picWidth − 1, x) ][ Reflect( picHeight − 1, y ) ]
else if( nnpfc_padding_type = = 3 )
        if( y >= 0 && y < picHeight )
              sampleVal = croppedPic[ Wrap( picWidth − 1, x ) ][ y ]
else if( nnpfc_padding_type = = 4 )
        if( y < 0 | | x < 0 | | y >= picHeight | | x >= picWidth )
              sampleVal[ 0 ] = nnpfc_luma_padding_val
                sampleVal[ 1 ] = nnpfc_cb_padding_val
              sampleVal[ 2 ] = nnpfc_cr_padding_val
        else
              sampleVal = croppedPic[ x ][ y ]
```

The following example process may be used to filter the cropped decoded output picture patch-wise with the post-processing filter PostProcessingFilter( ) to generate the filtered picture, which contains Y, Cb, and Cr sample arrays FilteredYPic, FilteredCbPic, and FilteredCrPic, respectively, as indicated by nnpfc_out_order_idc.

```
if( nnpfc_inp_order_idc = = 0 )
        for( cTop = 0; cTop < CroppedHeight; cTop += inpPatchHeight )
              for( cLeft = 0; cLeft < CroppedWidth; cLeft += inpPatchWidth ) {
                DeriveInputTensors( )
                outputTensor = PostProcessingFilter( inputTensor )
                StoreOutputTensors( )
              }
else if( nnpfc_inp_order_idc = = 1 )
        for( cTop = 0; cTop < CroppedHeight / SubHeightC; cTop += inpPatchHeight )
              for( cLeft = 0; cLeft < CroppedWidth / SubWidthC; cLeft += inpPatchWidth ) {
                DeriveInputTensors( )
                outputTensor = PostProcessingFilter( inputTensor )
                StoreOutputTensors( )
              }
else if( nnpfc_inp_order_idc = = 2)
        for( cTop = 0; cTop < CroppedHeight; cTop += inpPatchHeight) (92)
              for( cLeft = 0; cLeft < CroppedWidth; cLeft += inpPatchWidth) {
                DeriveInputTensors( )
                outputTensor = PostProcessingFilter( inputTensor )
                StoreOutputTensors( )
              }
else if( nnpfc_inp_order_idc = = 3)
        for( cTop = 0; cTop < CroppedHeight; cTop += inpPatchHeight * 2 )
              for( cLeft = 0; cLeft < CroppedWidth; cLeft += inpPatchWidth * 2 ) {
                DeriveInputTensors( )
                outputTensor = PostProcessingFilter( inputTensor )
                StoreOutputTensors( )
              }
```

nnpfc_complexity_info_present_flag equal to 1 specifies that one or more syntax elements that indicate the complexity of the post-processing filter associated with the nnpfc_id are present. nnpfc_complexity_info_present_flag equal to 0 specifies that no syntax elements that indicates the complexity of the post-processing filter associated with the nnpfc_id are present.

nnpfc_parameter_type_idc equal to 0 indicates that the neural network uses only integer parameters. nnpfc_parameter_type_flag equal to 1 indicates that the neural network may use floating point or integer parameters. nnpfc_parameter_type_idc equal to 2 indicates that the neural network uses only binary parameters. nnpfc_parameter_type_idc equal to 3 is reserved for future use by ITU-T|ISO/IEC and shall not be present in bitstreams conforming to this edition of this document. Decoders conforming to this edition of this document shall ignore NNPFC SEI messages with nnpfc_parameter_type_idc equal to 3.

nnpfc_log 2_parameter_bit_length_minus3 equal to 0, 1, 2, and 3 indicates that the neural network does not use parameters of bit length greater than 8, 16, 32, and 64, respectively. When nnpfc_parameter_type_idc is present and nnpfc_log 2_parameter_bit_length_minus3 is not present the neural network does not use parameters of bit length greater than 1.

nnpfc_num_parameters_idc indicates the maximum number of neural network parameters for the post processing filter in units of a power of 2048. nnpfc_num_parameters_idc equal to 0 indicates that the maximum number of neural network parameters is unknown. The value nnpfc_num_parameters_idc shall be in the range of 0 to 52, inclusive. Values of nnpfc_num_parameters_idc greater than 52 are reserved for future use by ITU-T|ISO/IEC and shall not be present in bitstreams conforming to this edition of this document. Decoders conforming to this edition of this document shall ignore NNPFC SEI messages with nnpfc_num_parameters_idc greater than 52.

If the value of nnpfc_num_parameters_idc is greater than zero, the variable maxNumParameters is derived as follows:

$$maxNumParameters = ( 2048 << nnpfc\_num\_parameters\_idc ) - 1 \qquad ( 93 )$$

It is a requirement of bitstream conformance that the number of neural network parameters of the post-processing filter shall be less than or equal to maxNumParameters.

nnpfc_num_kmac_operations_idc greater than 0 indicates that the maximum number of multiply-accumulate operations per sample of the post-processing filter is less than or equal to nnpfc_num_kmac_operations_idc*1000. nnpfc_num_kmac_operations_idc equal to 0 indicates that the maximum number of multiply-accumulate operations of the network is unknown. The value of nnpfc_num_kmac_operations_idc shall be in the range of 0 to 2³²−1, inclusive.

nnpfc_total_kilobyte_size greater than 0 indicates a total size in kilobytes required to store the uncompressed parameters for the neural network. The total size in bits is a number equal to or greater than the sum of bits used to store each parameter. nnpfc_total_kilobyte_size is the total size in bits divided by 8000, rounded up. nnpfc_total_kilobyte_size equal to 0 indicates that the total size required to store the parameters for the neural network is unknown. The value of nnpfc_total_kilobyte_size shall be in the range of 0 to 2³²−1, inclusive.

nnpfc_reserved_zero_bit_b shall be equal to 0 in bitstreams conforming to this edition of this document. Decoders shall ignore NNPFC SEI messages in which nnpfc_reserved_zero_bit_b is not equal to 0.

nnpfc_payload_byte[i] contains the i-th byte of a bitstream conforming to ISO/IEC 15938-17. The byte sequence nnpfc_payload_byte[i] for all present values of i shall be a complete bitstream that conforms to ISO/IEC 15938-17.

### 8.29 Neural-Network Post-Filter Activation SEI Message

### 8.29.1 Neural-Network Post-Filter Activation SEI Message Syntax

| nn_post_filter_activation( payloadSize ) { | Descriptor |
|---|---|
| nnpfa_target_id | ue(v) |
| nnpfa_cancel_flag | u(1) |
| if( !nnpfa_cancel_flag ) { | |
| nnpfa_persistence_flag | u(1) |
| } | |

### 8.29.2 Neural-Network Post-Filter Activation SEI Message Semantics

The neural-network post-filter activation (NNPFA) SEI message activates or de-activates the possible use of the target neural-network post-processing filter, identified by nnpfa_target_id, for post-processing filtering of a set of pictures.

NOTE 1—There can be several NNPFA SEI messages present for the same picture, for example, when the post-processing filters are meant for different purposes or filter different colour components.

nnpfa_target_id indicates the target neural-network post-processing filter, which is specified by one or more neural-network post-processing filter characteristics SEI messages that pertain to the current picture and have nnpfc_id equal to nnfpa_target_id.

The value of nnpfa_target_id shall be in the range of 0 to 2³²−2, inclusive. Values of nnpfa_target_id from 256 to 511, inclusive, and from 2³¹ to 2³²−2, inclusive, are reserved for future use by ITU-T|ISO/IEC. Decoders conforming to this edition of this document encountering an NNPFA SEI message with nnpfa_target_id in the range of 256 to 511, inclusive, or in the range of 2³¹ to 2³²−2, inclusive, shall ignore the SEI message.

An NNPFA SEI message with a particular value of nnpfa_target_id shall not be present in a current PU unless one or both of the following conditions are true:
Within the current CLVS there is an NNPFC SEI message with nnpfc_id equal to the particular value of nnpfa_target_id present in a PU preceding the current PU in decoding order.
There is an NNPFC SEI message with nnpfc_id equal to the particular value of nnpfa_target_id in the current PU.

When a PU contains both an NNPFC SEI message with a particular value of nnpfc_id and an NNPFA SEI message with nnpfa_target_id equal to the particular value of nnpfc_id, the NNPFC SEI message shall precede the NNPFA SEI message in decoding order.

nnpfa_cancel_flag equal to 1 indicates that the persistence of the target neural-network post-processing filter established by any previous NNPFA SEI message with the same nnpfa_target_id as the current SEI message is cancelled, i.e., the target neural-network post-processing filter is no longer used unless it is activated by another NNPFA SEI message with the same nnpfa_target_id as the current SEI message and nnpfa_cancel_flag equal to 0. nnpfa_cancel_flag equal to 0 indicates that the nnpfa_persistence_flag follows.

nnpfa_persistence_flag specifies the persistence of the target neural-network post-processing filter for the current layer.

nnpfa_persistence_flag equal to 0 specifies that the target neural-network post-processing filter may be used for post-processing filtering for the current picture only.

nnpfa_persistence_flag equal to 1 specifies that the target neural-network post-processing filter may be used for post-processing filtering for the current picture and all subsequent pictures of the current layer in output order until one or more of the following conditions are true:
A new CLVS of the current layer begins.
The bitstream ends.
A picture in the current layer associated with a NNPFA SEI message with the same nnpfa_target_id as the current SEI message and nnpfa_cancel_flag equal to 1 is output that follows the current picture in output order.

NOTE 2—The target neural-network post-processing filter is not applied for this subsequent picture in the current layer associated with a NNPFA SEI message with the same nnpfa_target_id as the current SEI message and nnpfa_cancel_flag equal to 1.

### 4. TECHNICAL PROBLEMS SOLVED BY DISCLOSED TECHNICAL SOLUTIONS

An example design for the neural-network post-filter characteristics (NNPFC) SEI message and the neural-network post-filter activation (NNPFA) SEI message has the following problems:

First, when the input of an NNPF activated for a particular current picture includes at least a picture picX that is not the current picture, it is unclear whether picX used in the input shall be the picX before or after applying the NNPF.

Second, when two or more NNPFs, including NNPFa and NNPFb, are activated for a particular current picture, NNPFa is applied before NNPFb, and the input of NNPFb includes at least a picture picX that may or may not be the current picture, it is unclear whether picX used in the input of NNPFb is the picX before or after applying NNPFa.

Third, when multiple NNPFs are activated for a particular picture, a preferred processing order for the NNPFs can produce better results than other orders. At the same time, the nnpfc_id that identifies an NNPF can also be used to indicate a preferred order of processing of the NNPF relative to other NNPFs.

Fourth, for some NNPFs, it might be desirable to limit the input pictures such that the NNPF can be applied real-time when decoding the pictures in the bitstream. When such limit is placed, it would be desirable to indicate this in the bitstream such that it known that such way of applying an NNPF is enabled.

### 5. A LISTING OF SOLUTIONS AND EMBODIMENTS

To solve the above-described problems, methods as summarized below are disclosed. The aspects should be considered as examples to explain the general concepts and should not be interpreted in a narrow way. Furthermore, these examples can be applied individually or combined in any manner.
1) It is specified that, when the input of an NNPF activated for a particular current picture includes the current picture, the current picture used in the input is the current picture before applying the NNPF.
2) (no signalling, same filter) To solve problem 1, it is specified that, when the input of an NNPF activated for a particular current picture includes a picture picX that is not the current picture, one or more of the following aspects apply:
   a. In one example, when the input picture picX precedes the current picture in output order, picX used in the input shall be the picX after applying the NNPF.
   b. In one example, when the input picture picX follows the current picture in output order, picX used in the input shall be pixX before applying the NNPF.
   c. In one example, when the input picture picX precedes the current picture in decoding order, picX used in the input shall be the picX after applying the NNPF.
   d. In one example, when the input picture picX follows the current picture in decoding order, picX used in the input shall be pixX before applying the NNPF.
   e. In one example, picX used in the input shall be the picX after applying the NNPF.
   f. In one example, picX used in the input shall be pixX before applying the NNPF.
3) (no signalling, same filter) To solve problem 1, it is specified that, when multiple pictures are used as the input by an NNPF activated for a particular current picture one or more of the following aspects apply:
   a. In one example, it is specified that, when multiple pictures are used as the input by an NNPF activated for a particular current picture, all the input pictures preceding the current picture in output order shall be pictures after applying the NNPF, and all the input pictures following the current picture in output order shall be pictures before applying the NNPF.
   b. In one example, it is specified that, when multiple pictures are used as the input by an NNPF activated for a particular current picture, all the input pictures preceding the current picture in decoding order shall be pictures after applying the NNPF, and all the input pictures following the current picture in decoding order shall be pictures before applying the NNPF.
   c. In one example, it is specified that, when multiple pictures are used as the input by an NNPF activated for a particular current picture, all the input pictures excluding the current picture itself shall be pictures before applying the NNPF.
   d. In one example, it is specified that, when multiple pictures are used as the input by an NNPF activated for a particular current picture, all the input pictures excluding the current picture itself shall be pictures after applying the NNPF.
4) (with signalling, same filter) To solve problem 1, when multiple input pictures are signalled for an NNPF in the NNPFC SEI message, an indication indicating the use of pictures before or after applying the NNPF is signalled in the NNPFC SEI message or in the NNPFA SEI message, and it is specified that, when multiple pictures are used as the input by an NNPF activated for a particular current picture, one or more of the following aspects apply:
   a. In one example, furthermore, one particular value of the indication indicates that, when multiple pictures are used as the input by an NNPF activated for a particular current picture, all the input pictures preceding the current picture in output order shall be pictures after applying the NNPF, and all the input pictures following the current picture in output order shall be pictures before applying the NNPF.
   b. In one example, furthermore, one particular value of the indication indicates that, when multiple pictures are used as the input by an NNPF activated for a particular current picture, all the input pictures preceding the current picture in decoding order shall be pictures after applying the NNPF, and all the input pictures following the current picture in decoding order shall be pictures before applying the NNPF.
   c. In one example, furthermore, one particular value of the indication indicates that, when multiple pictures are used as the input by an NNPF activated for a particular current picture, all the input pictures excluding the current picture itself shall be pictures before applying the NNPF.
   d. In one example, furthermore, one particular value of the indication indicates that, when multiple pictures are used as the input by an NNPF activated for a particular current picture, all the input pictures excluding the current picture itself shall be pictures after applying the NNPF.
5) (no signalling, cross filters) To solve problem 2, it is specified that, when two or more NNPFs, including NNPFa and NNPFb, are activated for a particular current picture, and it is indicated that NNPFb is applied immediately after applying NNPFa, one or more of the following aspects are specified:
   a. In one example, when the input of NNPFb includes the current picture, the current picture after applying NNPFa and before applying NNPFb shall be used.
   b. In one example, when the input of NNPFb includes a picture picX preceding the current picture in output order, the picture picX after applying NNPFa and after applying NNPFb shall be used.
   c. In one example, when the input of NNPFb includes a picture picX preceding the current picture in output order, the picture picX after applying NNPFa and before applying NNPFb shall be used.
   d. In one example, when the input of NNPFb includes a picture picX preceding the current picture in output order, the picture picX before applying NNPFa and before applying NNPFb shall be used.
   e. In one example, when the input of NNPFb includes a picture picX following the current picture in output order, the picture picX before applying NNPFa and before applying NNPFb shall be used.
   f. In one example, when the input of NNPFb includes a picture picX following the current picture in output order, the picture picX after applying NNPFa and before applying NNPFb shall be used.
   g. In one example, when the input of NNPFb includes a picture picX following the current picture in output order, the picture picX after applying NNPFa and after applying NNPFb shall be used.
   h. In one example, when the input of NNPFb includes a picture picX preceding the current picture in decoding order, the picture picX after applying NNPFa and after applying NNPFb shall be used.
   i. In one example, when the input of NNPFb includes a picture picX preceding the current picture in decoding order, the picture picX after applying NNPFa and before applying NNPFb shall be used.
   j. In one example, when the input of NNPFb includes a picture picX preceding the current picture in decoding order, the picture picX before applying NNPFa and before applying NNPFb shall be used.
   k. In one example, when the input of NNPFb includes a picture picX following the current picture in decoding order, the picture picX before applying NNPFa and before applying NNPFb shall be used.
   l. In one example, when the input of NNPFb includes a picture picX following the current picture in decoding order, the picture picX after applying NNPFa and before applying NNPFb shall be used.
   m. In one example, when the input of NNPFb includes a picture picX following the current picture in decoding order, the picture picX after applying NNPFa and after applying NNPFb shall be used.
   n. In one example, when the input of NNPFb includes a picture picX that is not the current picture, the picture picX after applying NNPFa and after applying NNPFb shall be used.
   o. In one example, when the input of NNPFb includes a picture picX that is not the current picture, the picture picX after applying NNPFa and before applying NNPFb shall be used.
   p. In one example, when the input of NNPFb includes a picture picX that is not the current picture, the picture picX before applying NNPFa and before applying NNPFb shall be used.
   q. In one example, when the purpose of NNPFa is related to resampling, and the input of NNPFb includes the current picture, the current picture after applying NNPFa and before applying NNPFb shall be used.
      i. In one example, the resampling may be upsampling or downsampling for frame rate, bitdepth, resolution, chroma format.
6) (combined signalling, cross filters) To solve problem 2, an indication indicating the use of pictures before or after applying an NNPF is signalled in the NNPFC SEI message or in the NNPFA SEI message, and it is specified that, when two or more NNPFs, including the current NNPF NNPFb (i.e., the NNPF specified by the current NNPFC SEI message) and another NNPF NNPFa, are activated for a particular current picture, and it is indicated that NNPFb is applied immediately after applying NNPFa, one or more of the following aspects apply:
   a. In one example, when the input of NNPFb includes the current picture, the current picture after applying NNPFa and before applying NNPFb shall be used.
   b. In one example, when the input of NNPFb includes multiple current pictures, the current picture after applying NNPFa and before applying NNPFb together with the current picture before applying NNPFa shall be used.
   c. In one example, one particular value of the indication indicates that, when the input of NNPFb includes a picture picX preceding the current picture in output order, the picture picX after applying NNPFa and after applying NNPFb shall be used.
   d. In one example, one particular value of the indication indicates that, when the input of NNPFb includes a picture picX preceding the current picture in output order, the picture picX after applying NNPFa and before applying NNPFb shall be used.
   e. In one example, one particular value of the indication indicates that, when the input of NNPFb includes a picture picX preceding the current picture in output order, the picture picX before applying NNPFa and before applying NNPFb shall be used.
   f. In one example, one particular value of the indication indicates that, when the input of NNPFb includes a picture picX following the current picture in output order, the picture picX before applying NNPFa and before applying NNPFb shall be used.
   g. In one example, one particular value of the indication indicates that, when the input of NNPFb includes a picture picX following the current picture in output order, the picture picX after applying NNPFa and before applying NNPFb shall be used.
   h. In one example, one particular value of the indication indicates that, when the input of NNPFb includes a picture picX following the current picture in output order, the picture picX after applying NNPFa and after applying NNPFb shall be used.
   i. In one example, one particular value of the indication indicates that, when the input of NNPFb includes a picture picX preceding the current picture in decoding order, the picture picX after applying NNPFa and after applying NNPFb shall be used.
   j. In one example, one particular value of the indication indicates that, when the input of NNPFb includes a picture picX preceding the current picture in decoding order, the picture picX after applying NNPFa and before applying NNPFb shall be used.
   k. In one example, one particular value of the indication indicates that, when the input of NNPFb includes a picture picX preceding the current picture in decoding order, the picture picX before applying NNPFa and before applying NNPFb shall be used.
   l. In one example, one particular value of the indication indicates that, when the input of NNPFb includes a picture picX following the current picture in decoding order, the picture picX before applying NNPFa and before applying NNPFb shall be used.
   m. In one example, one particular value of the indication indicates that, when the input of NNPFb includes a picture picX following the current picture in decoding order, the picture picX after applying NNPFa and before applying NNPFb shall be used.
   n. In one example, one particular value of the indication indicates that, when the input of NNPFb includes a picture picX following the current picture in decoding order, the picture picX after applying NNPFa and after applying NNPFb shall be used.
   o. In one example, one particular value of the indication indicates that, when the input of NNPFb includes a picture picX that is not the current picture, the picture picX after applying NNPFa and after applying NNPFb shall be used.
   p. In one example, one particular value of the indication indicates that, when the input of NNPFb includes a picture picX that is not the current picture, the picture picX after applying NNPFa and before applying NNPFb shall be used.
   q. In one example, one particular value of the indication indicates that, when the input of NNPFb includes a picture picX that is not the current picture, the picture picX before applying NNPFa and before applying NNPFb shall be used.
   r. In one example, the indication may be NOT signaled when the purpose of NNPFa is related to resampling.
      i. In one example, the resampling may be upsampling or downsampling for frame rate, bitdepth, resolution, chroma format.
      ii. In one example, one of the examples disclosed above may be used as default when the indication is NOT signaled.
   s. In one example, the indication may be signaled when the purpose of NNPFa is related to quality enhancement
7) (separate signalling, cross filters) To solve problem 2, two indications, idcB and idcA, are signalled in the NNPFC SEI message or in the NNPFA SEI message, idcB indicating the use of pictures before or after applying the current NNPF same as in item 2), and idcA indicating the use of pictures before or after applying another NNPF that is to be immediately applied before applying the current NNPF, and it is specified that, when two or more NNPFs, including the current NNPF NNPFb and another NNPF NNPFa, are activated for a particular current picture, and it is indicated that NNPFb is applied immediately after applying NNPFa, one or more of the following aspects apply:
   a. In one example, when the input of NNPFb includes the current picture, the current picture after applying NNPFa and before applying NNPFb shall be used.
   b. In one example, one particular value of idcA indicates that, when the input of NNPFb includes a picture picX preceding the current picture in output order, the picture picX used in the input shall be after applying NNPFa, and whether it shall be before or after applying NNPFb is determined by the value of idcB.
   c. In one example, one particular value of idcA indicates that, when the input of NNPFb includes a picture picX preceding the current picture in output order, the picture picX used in the input shall be before applying NNPFa, and whether it shall be before or after applying NNPFb is determined by the value of idcB.
   d. In one example, one particular value of idcA indicates that, when the input of NNPFb includes a picture picX following the current picture in output order, the picture picX used in the input shall be after applying NNPFa, and whether it shall be before or after applying NNPFb is determined by the value of idcB.
   e. In one example, one particular value of idcA indicates that, when the input of NNPFb includes a picture picX following the current picture in output order, the picture picX used in the input shall be before applying NNPFa, and whether it shall be before or after applying NNPFb is determined by the value of idcB.
   f. In one example, one particular value of idcA indicates that, when the input of NNPFb includes a picture picX preceding the current picture in decoding order, the picture picX used in the input shall be after applying NNPFa, and whether it shall be before or after applying NNPFb is determined by the value of idcB.
   g. In one example, one particular value of idcA indicates that, when the input of NNPFb includes a picture picX preceding the current picture in decoding order, the picture picX used in the input shall be before applying NNPFa, and whether it shall be before or after applying NNPFb is determined by the value of idcB.
   h. In one example, one particular value of idcA indicates that, when the input of NNPFb includes a picture picX following the current picture in decoding order, the picture picX used in the input shall be after applying NNPFa, and whether it shall be before or after applying NNPFb is determined by the value of idcB.
   i. In one example, one particular value of idcA indicates that, when the input of NNPFb includes a picture picX following the current picture in decoding order, the picture picX used in the input shall be before applying NNPFa, and whether it shall be before or after applying NNPFb is determined by the value of idcB.
   j. In one example, one particular value of idcA indicates that, when the input of NNPFb includes a picture picX that is not the current picture, the picture picX used in the input shall be after applying NNPFa, and whether it shall be before or after applying NNPFb is determined by the value of idcB.
   k. In one example, one particular value of idcA indicates that, when the input of NNPFb includes a picture picX that is not the current picture, the picture picX used in the input shall be before applying NNPFa, and whether it shall be before or after applying NNPFb is determined by the value of idcB.
8) (no signalling, ID indicates processing order) To solve problem 3, it is specified that, nnpfc_id not only contains an identifying number that may be used to identify a post-processing filter, but also indicates the preferred order of processing of the post-processing filter.
   a. In one example, furthermore, when multiple NNPFC SEI messages are present, a value of nnpfc_id in this NNPFC SEI message less than the value of nnpfc_id in another NNPFC SEI message indicates the post-processing filter specified in this NNPFC SEI message, if activated by an NNPFA SEI message, should be processed before the post-processing filter specified in the other NNPFC SEI message, if activated by an NNPFA SEI message.
9) (with signalling, ID indicates processing order) To solve problem 3, a flag, e.g., named nnpfc_id_also_indicates_processing_order_flag, is added to the NNPFC SEI message syntax, to indicate whether different values of nnpfc_id for different NNPFs also indicate preferred processing order of the different NNPFs. Furthermore, one or more of the following aspects are specified:
   a. In one example, furthermore, when nnpfc_id_also_indicates_processing_order_flag is equal to 1, nnpfc_id not only contains an identifying number that may be used to identify a post-processing filter, but also indicates the preferred order of processing of the post-processing filter.
      i. In one example, furthermore, when multiple NNPFC SEI messages are present, a value of nnpfc_id in this NNPFC SEI message less than the value of nnpfc_id in another NNPFC SEI message indicates the post-processing filter specified in this NNPFC SEI message, if activated by an NNPFA SEI message, should be processed before the post-processing filter specified in the other NNPFC SEI message, if activated by an NNPFA SEI message.
   b. In one example, furthermore, when nnpfc_id_also_indicates_processing_order_flag is equal to 0, nnpfc_id contains an identifying number that may be used to identify a post-processing filter, but does not indicates the preferred order of processing of the post-processing filter.
   c. In one example, furthermore, when nnpfc_id_also_indicates_processing_order_flag is equal to 0, the preferred order of processing of the post-processing filter is unknown.
   d. In one example, furthermore, when nnpfc_id_also_indicates_processing_order_flag is equal to 0 for two NNPFs, there is no preferred order of processing of the two NNPFs.
10) To solve problem 3, in one example, it is specified that the order of applying the NNPFs for a specific picture follows the activation order indicated by the corresponding NNPFA messages.
   a. Alternatively, the order of applying NNPFs for a specific picture is the reverse of the activation order indicated by the corresponding NNPFA messages.
11) To solve problem 4, an indication indicating whether applying NNPFC for any current picture is based on the decoding order of pictures is signalled in the NNPFC SEI message. Furthermore, one or more of the following aspects apply:
   a. In one example, one particular value of the indication indicates that all pictures in the input of the NNPF when applied for any current picture are before the current picture in the decoding order. This enables that the NNPF can be applied while decoding the pictures in real time.
   b. In one example, one particular value of the indication indicates that, the input signal in the specific picture before the current picture in the decoding picture order shall be used.
   c. In one example, one particular value of the indication indicates that, the input signal in the specific picture before the current picture in the decoding picture order shall be NOT used.
   d. In one example, one particular value of the indication indicates that, the input signal in the specific picture after the current picture in the decoding picture order shall be used.
   e. In one example, one particular value of the indication indicates that, the input signal in the specific picture after the current picture in the decoding picture order shall be NOT used.
   f. In one example, one particular value of the indication indicates that, the input signal in the specific picture before the current picture in the output picture order shall be used.
   g. In one example, one particular value of the indication indicates that, the input signal in the specific picture before the current picture in the output picture order shall be NOT used.
   h. In one example, one particular value of the indication indicates that, the input signal in the specific picture after the current picture in the output picture order shall be used.
   i. In one example, one particular value of the indication indicates that, the input signal in the specific picture after the current picture in the output picture order shall be NOT used.
12) In one example, a message may be signaled from the encoder to the decoder to indicate whether an input picture to the NNPF shall be the picture before or after a process.
   a. The input picture may be the current picture.
   b. The input picture may be a reference picture.
   c. The message may be signaled in an SEI message.
      i. The SEI message may be NNPFC and/or NNPFA.
   d. The process may be ALF, Cross Component ALF (CC-ALF), Bilateral filter(BIF), Chroma-BIF, SAO, Deblocking, etc. or any combination of these processes.
13) In the disclosed methods in this document, the statement “before or after applying an NNPF” may be replaced by “before or after applying a process”.
   a. The process may be ALF, BIF, SAO, Deblocking, etc. or any combination of these processes.
14) Whether to and/or how to apply the methods disclosed in this document, may depend on coding information such as color format, color component, resolution, QP, temporal layer, Picture Order Count (POC), etc.
15) Whether to and/or how to apply the methods disclosed in this document, may depend on a SEI message, different from NNPFC or NNPFA.

### 6. EMBODIMENTS

Below are some example embodiments for the aspects summarized in section 5. Most relevant parts that have been added or modified are shown in bold font, and some of the deleted parts are shown in italicized bold fonts. There may be some other changes that are editorial in nature and thus not highlighted.

### 7. References

[1] ITU-T and ISO/IEC, “High efficiency video coding”, Rec. ITU-T H.265|ISO/IEC 23008-2 (in force edition).
[2] J. Chen, E. Alshina, G. J. Sullivan, J.-R. Ohm, J. Boyce, “Algorithm description of Joint Exploration Test Model 7 (JEM7),” JVET-G1001, August 2017.
[3] Rec. ITU-T H.266|ISO/IEC 23090-3, “Versatile Video Coding”, 2022.
[4] Rec. ITU-T Rec. H.274|ISO/IEC 23002-7, “Versatile Supplemental Enhancement Information Messages for Coded Video Bitstreams”, 2022.
[5] ISO/IEC JTC 1/SC 29/WG 05 output document NO158, “Text of ISO/IEC 23002-7: 202x (2nd Ed.) DAM 1 Information technology—MPEG video technologies—Part 7: Versatile supplemental enhancement information messages for coded video bitstreams, AMENDMENT 1: Additional SEI messages”, October 2022.
[6] S. McCarthy, T. Chujoh, M. Hannuksela, G. Sullivan, and Y.-K. Wang (editors), “Additional SEI messages for VSEI (Draft 3),” JVET output document JVET-AB2006, publicly available online herein: https://www.jvet-experts.org/doc_end_user/current_document.php?id=12215.

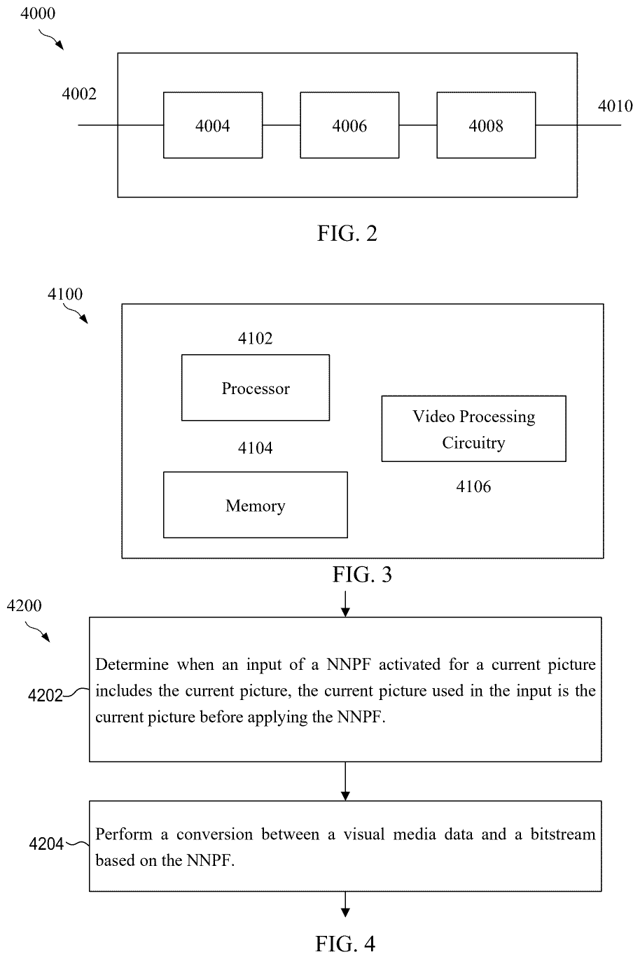

FIG. 2 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present document. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present document may be embodied in various electronic devices such as mobile phones, laptops, smartphones or other devices that are capable of performing digital data processing and/or video display.

FIG. 3 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present document. The memory (memories) 4104 may be used for storing data and code used for implementing the methods and techniques described herein. The video processing circuitry 4106 may be used to implement, in hardware circuitry, some techniques described in the present document. In some embodiments, the video processing circuitry 4106 may be at least partly included in the processor 4102, e.g., a graphics co-processor.

FIG. 4 is a flowchart for an example method 4200 of video processing. The method 4200 determines when an input of a neural-network post-filter (NNPF) activated for a current picture includes the current picture, the current picture used in the input is the current picture before applying the NNPF at step 4202. A conversion is performed between a visual media data and a bitstream based on the NNPF at step 4204. The conversion may include encoding at an encoder, decoding at a decoder, or combinations thereof.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

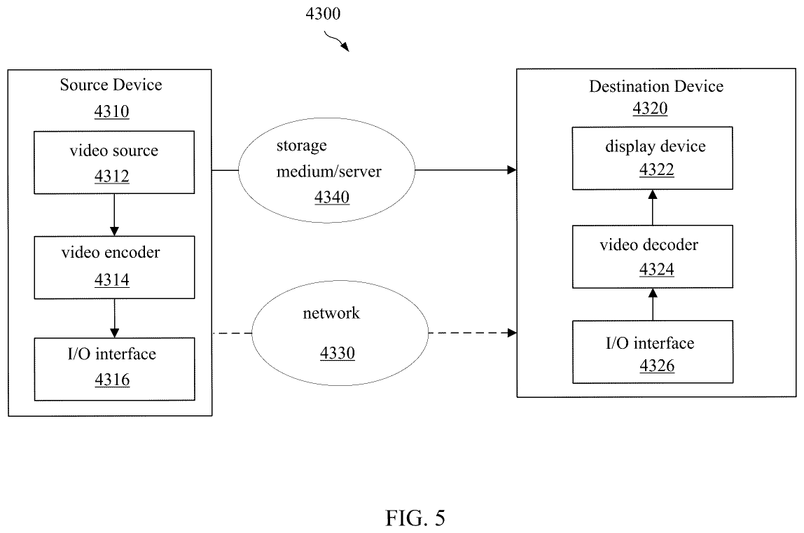

FIG. 5 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

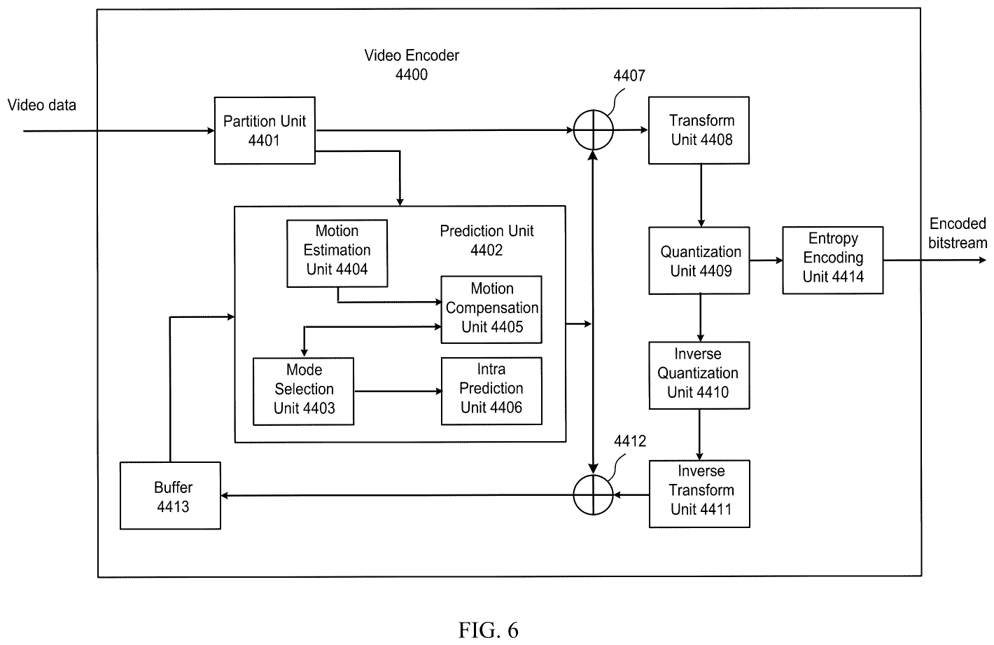

FIG. 6 is a block diagram illustrating an example of video encoder 4400, which may be video encoder 4314 in the system 4300 illustrated in FIG. 5. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

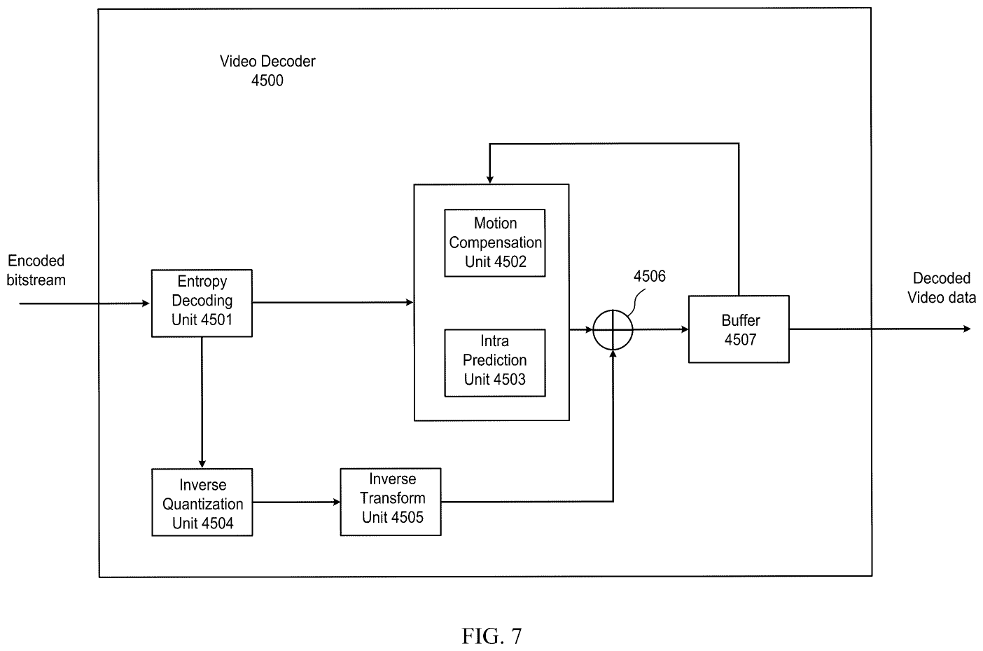

FIG. 7 is a block diagram illustrating an example of video decoder 4500 which may be video decoder 4324 in the system 4300 illustrated in FIG. 5. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

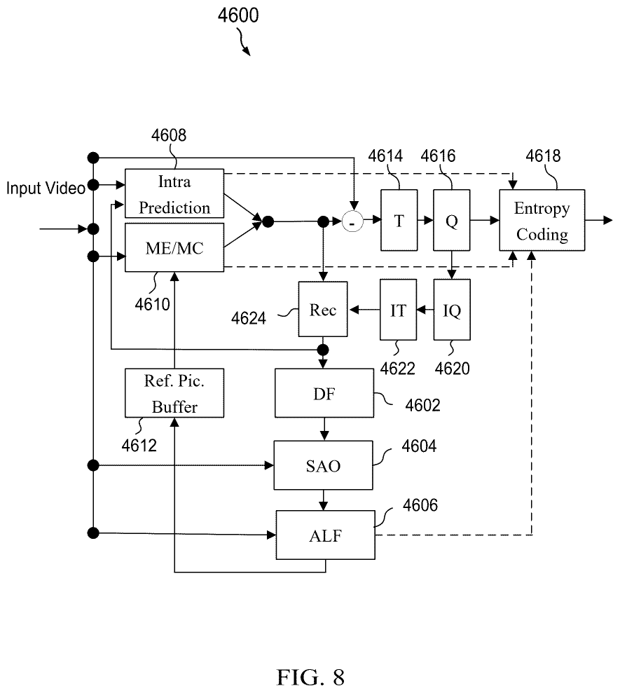

FIG. 8 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of techniques discussed herein.
1. A method for processing media data comprising: determining when an input of a neural-network post-filter (NNPF) activated for a current picture includes the current picture, the current picture used in the input is the current picture before applying the NNPF; and performing a conversion between a visual media data and a bitstream based on the NNPF.
2. The method of solution 1, wherein when the input of the NNPF activated for the current picture includes a picture (picX) that is not the current picture, one or more of the following apply: when picX precedes the current picture in output order, picX used in the input shall be the picX after applying the NNPF; when picX follows the current picture in output order, picX used in the input shall be picX before applying the NNPF; when picture picX precedes the current picture in decoding order, picX used in the input shall be picX after applying the NNPF; when picX follows the current picture in decoding order, picX used in the input shall be picX before applying the NNPF; picX used in the input shall be the picX after applying the NNPF; and picX used in the input shall be pixX before applying the NNPF.
3. The method of any of solutions 1-2, wherein when multiple pictures are used as the input by an NNPF activated for the current picture one or more of the following aspects apply: when multiple pictures are used as the input by an NNPF activated for the current picture, all the input pictures preceding the current picture in output order shall be pictures after applying the NNPF, and all the input pictures following the current picture in output order shall be pictures before applying the NNPF; when multiple pictures are used as the input by an NNPF activated for the current picture, all the input pictures preceding the current picture in decoding order shall be pictures after applying the NNPF, and all the input pictures following the current picture in decoding order shall be pictures before applying the NNPF; when multiple pictures are used as the input by an NNPF activated for the current picture, all the input pictures excluding the current picture itself shall be pictures before applying the NNPF; and when multiple pictures are used as the input by an NNPF activated for the current picture, all the input pictures excluding the current picture itself shall be pictures after applying the NNPF.
4. The method of any of solutions 1-3, wherein multiple input pictures are signaled for an NNPF in the neural-network post-filter characteristics (NNPFC) supplemental enhancement information (SEI) message, an indication indicating a use of pictures before or after applying the NNPF is signaled in the NNPFC SEI message or in a neural-network post-filter activation (NNPFA) SEI message, and wherein when multiple pictures are used as the input by an NNPF activated for the current picture, one or more of the following aspects apply: one particular value of the indication indicates that, when multiple pictures are used as the input by an NNPF activated for a particular current picture, all the input pictures preceding the current picture in output order shall be pictures after applying the NNPF, and all the input pictures following the current picture in output order shall be pictures before applying the NNPF; one particular value of the indication indicates that, when multiple pictures are used as the input by an NNPF activated for a particular current picture, all the input pictures preceding the current picture in decoding order shall be pictures after applying the NNPF, and all the input pictures following the current picture in decoding order shall be pictures before applying the NNPF; one particular value of the indication indicates that, when multiple pictures are used as the input by an NNPF activated for a particular current picture, all the input pictures excluding the current picture itself shall be pictures before applying the NNPF; and one particular value of the indication indicates that, when multiple pictures are used as the input by an NNPF activated for a particular current picture, all the input pictures excluding the current picture itself shall be pictures after applying the NNPF.
5. The method of any of solutions 1-4, wherein when two or more NNPFs, including NNPFa and NNPFb, are activated for the current picture, and an indication indicated that NNPFb is applied immediately after applying NNPFa; one or more of the following apply: when the input of NNPFb includes the current picture, the current picture after applying NNPFa and before applying NNPFb shall be used; when the input of NNPFb includes a picture picX preceding the current picture in output order, the picture picX after applying NNPFa and after applying NNPFb shall be used; when the input of NNPFb includes a picture picX preceding the current picture in output order, the picture picX after applying NNPFa and before applying NNPFb shall be used; when the input of NNPFb includes a picture picX preceding the current picture in output order, the picture picX before applying NNPFa and before applying NNPFb shall be used; when the input of NNPFb includes a picture picX following the current picture in output order, the picture picX before applying NNPFa and before applying NNPFb shall be used; when the input of NNPFb includes a picture picX following the current picture in output order, the picture picX after applying NNPFa and before applying NNPFb shall be used; when the input of NNPFb includes a picture picX following the current picture in output order, the picture picX after applying NNPFa and after applying NNPFb shall be used; when the input of NNPFb includes a picture picX preceding the current picture in decoding order, the picture picX after applying NNPFa and after applying NNPFb shall be used; when the input of NNPFb includes a picture picX preceding the current picture in decoding order, the picture picX after applying NNPFa and before applying NNPFb shall be used; when the input of NNPFb includes a picture picX preceding the current picture in decoding order, the picture picX before applying NNPFa and before applying NNPFb shall be used; when the input of NNPFb includes a picture picX following the current picture in decoding order, the picture picX before applying

NNPFa and before applying NNPFb shall be used; when the input of NNPFb includes a picture picX following the current picture in decoding order, the picture picX after applying NNPFa and before applying NNPFb shall be used; when the input of NNPFb includes a picture picX following the current picture in decoding order, the picture picX after applying NNPFa and after applying NNPFb shall be used; when the input of NNPFb includes a picture picX that is not the current picture, the picture picX after applying NNPFa and after applying NNPFb shall be used; when the input of NNPFb includes a picture picX that is not the current picture, the picture picX after applying NNPFa and before applying NNPFb shall be used; when the input of NNPFb includes a picture picX that is not the current picture, the picture picX before applying NNPFa and before applying NNPFb shall be used; and when the purpose of NNPFa is related to resampling, and the input of NNPFb includes the current picture, the current picture after applying NNPFa and before applying NNPFb shall be used.
6. The method of any of solutions 1-5, wherein an indication indicating a use of pictures before or after applying an NNPF is signaled in the NNPFC SEI message or in the NNPFA SEI message, and wherein when two or more NNPFs, including NNPFb and NNPFa, are activated for the current picture, and an indicator indicates that NNPFb is applied immediately after applying NNPFa, one or more of the following apply: when the input of NNPFb includes the current picture, the current picture after applying NNPFa and before applying NNPFb shall be used; when the input of NNPFb includes multiple current pictures, the current picture after applying NNPFa and before applying NNPFb together with the current picture before applying NNPFa shall be used; one particular value of the indication indicates that, when the input of NNPFb includes a picture picX preceding the current picture in output order, the picture picX after applying NNPFa and after applying NNPFb shall be used; one particular value of the indication indicates that when the input of NNPFb includes a picture picX preceding the current picture in output order, the picture picX before applying NNPFa and before applying NNPFb shall be used; one particular value of the indication indicates that when the input of NNPFb includes a picture picX following the current picture in output order, the picture picX before applying NNPFa and before applying NNPFb shall be used; one particular value of the indication indicates that when the input of NNPFb includes a picture picX following the current picture in output order, the picture picX after applying NNPFa and before applying NNPFb shall be used; one particular value of the indication indicates that when the input of NNPFb includes a picture picX following the current picture in output order, the picture picX after applying NNPFa and after applying NNPFb shall be used; one particular value of the indication indicates that when the input of NNPFb includes a picture picX preceding the current picture in decoding order, the picture picX after applying NNPFa and after applying NNPFb shall be used; one particular value of the indication indicates that when the input of NNPFb includes a picture picX preceding the current picture in decoding order, the picture picX after applying NNPFa and before applying NNPFb shall be used; one particular value of the indication indicates that when the input of NNPFb includes a picture picX preceding the current picture in decoding order, the picture picX before applying NNPFa and before applying NNPFb shall be used; one particular value of the indication indicates that when the input of NNPFb includes a picture picX following the current picture in decoding order, the picture picX before applying NNPFa and before applying NNPFb shall be used; one particular value of the indication indicates that when the input of NNPFb includes a picture picX following the current picture in decoding order, the picture picX after applying NNPFa and before applying NNPFb shall be used; one particular value of the indication indicates that when the input of NNPFb includes a picture picX following the current picture in decoding order, the picture picX after applying NNPFa and after applying NNPFb shall be used; one particular value of the indication indicates that when the input of NNPFb includes a picture picX that is not the current picture, the picture picX after applying NNPFa and after applying NNPFb shall be used; one particular value of the indication indicates that when the input of NNPFb includes a picture picX that is not the current picture, the picture picX after applying NNPFa and before applying NNPFb shall be used; one particular value of the indication indicates that when the input of NNPFb includes a picture picX that is not the current picture, the picture picX before applying NNPFa and before applying NNPFb shall be used; the indication may not be signaled when the purpose of NNPFa is related to resampling; and the indication may be signaled when the purpose of NNPFa is related to quality enhancement.
7. The method of any of solutions 1-6, wherein indications idcB and idcA are signalled in the NNPFC SEI message or in the NNPFA SEI message, wherein idcB indicates the use of pictures before or after applying a current NNPF, wherein idcA indicates a use of pictures before or after applying another NNPF that is to be immediately applied before applying the current NNPF, and wherein when two or more NNPFs, including the NNPFb and NNPFa, are activated for the current picture, and when an indicator indicates that NNPFb is applied immediately after applying NNPFa, one or more of the following apply: when the input of NNPFb includes the current picture, the current picture after applying NNPFa and before applying NNPFb shall be used; one particular value of idcA indicates that, when the input of NNPFb includes a picture picX preceding the current picture in output order, the picture picX used in the input shall be after applying NNPFa, and whether it shall be before or after applying NNPFb is determined by the value of idcB; one particular value of idcA indicates that, when the input of NNPFb includes a picture picX preceding the current picture in output order, the picture picX used in the input shall be before applying NNPFa, and whether it shall be before or after applying NNPFb is determined by the value of idcB; one particular value of idcA indicates that, when the input of NNPFb includes a picture picX following the current picture in output order, the picture picX used in the input shall be after applying NNPFa, and whether it shall be before or after applying NNPFb is determined by the value of idcB; one particular value of idcA indicates that, when the input of NNPFb includes a picture picX following the current picture in output order, the picture picX used in the input shall be before applying NNPFa, and whether it shall be before or after applying NNPFb is determined by the value of idcB; one particular value of idcA indicates that, when the input of NNPFb includes a picture picX preceding the current picture in decoding order, the picture picX used in the input shall be after applying NNPFa, and whether it shall be before or after applying NNPFb is determined by the value of idcB; one particular value of idcA indicates that, when the input of NNPFb includes a picture picX preceding the current picture in decoding order, the picture picX used in the input shall be before applying NNPFa, and whether it shall be before or after applying NNPFb is determined by the value of idcB; one particular value of idcA indicates that, when the input of NNPFb includes a picture picX following the current picture in decoding order, the picture picX used in the input shall be after applying NNPFa, and whether it shall be before or after applying NNPFb is determined by the value of idcB; one particular value of idcA indicates that, when the input of NNPFb includes a picture picX following the current picture in decoding order, the picture picX used in the input shall be before applying NNPFa, and whether it shall be before or after applying NNPFb is determined by the value of idcB; one particular value of idcA indicates that, when the input of NNPFb includes a picture picX that is not the current picture, the picture picX used in the input shall be after applying NNPFa, and whether it shall be before or after applying NNPFb is determined by the value of idcB; and one particular value of idcA indicates that, when the input of NNPFb includes a picture picX that is not the current picture, the picture picX used in the input shall be before applying NNPFa, and whether it shall be before or after applying NNPFb is determined by the value of idcB.
8. The method of any of solutions 1-7, wherein a NNPFC identifier (nnpfc_id) contains an identifying number used to identify a post-processing filter and also indicates a preferred order of processing of a post-processing filter.
9. The method of any of solutions 1-8, wherein when multiple NNPFC SEI messages are present, a value of nnpfc_id in this NNPFC SEI message less than the value of nnpfc_id in another NNPFC SEI message indicates the post-processing filter specified in this NNPFC SEI message, if activated by an NNPFA SEI message, should be processed before the post-processing filter specified in the other NNPFC SEI message, if activated by an NNPFA SEI message.
10. The method of any of solutions 1-9, wherein the NNPFC SEI message includes a flag to indicate whether different values of nnpfc_id for different NNPFs also indicate preferred processing order of the different NNPFs.
11. The method of any of solutions 1-10, wherein when multiple NNPFC SEI messages are present, a value of nnpfc_id in the NNPFC SEI message less than the value of nnpfc_id in another NNPFC SEI message indicates the post-processing filter specified in this NNPFC SEI message, if activated by an NNPFA SEI message, should be processed before the post-processing filter specified in the other NNPFC SEI message, if activated by an NNPFA SEI message.
12. The method of any of solutions when 1-11, wherein nnpfc_id_also_indicates_processing_order_flag is equal to 0, nnpfc_id contains an identifying number that identifies a post-processing filter, but does not indicates a preferred order of processing of the post-processing filter.
13. The method of any of solutions 1-12, wherein when nnpfc_id_also_indicates_processing_order_flag is equal to 0, a preferred order of processing of the post-processing filter is unknown.
14. The method of any of solutions 1-13, wherein when nnpfc_id_also_indicates_processing_order_flag is equal to 0 for two NNPFs, there is no preferred order of processing of the two NNPFs.
15. The method of any of solutions 1-14, wherein an order of applying the NNPFs for a specific picture follows the activation order indicated by the corresponding NNPFA messages.
16. The method of any of solutions 1-15, wherein an order of applying NNPFs for a specific picture is the reverse of the activation order indicated by the corresponding NNPFA messages.
17. The method of any of solutions 1-16, wherein an indication indicating whether applying NNPFC for any current picture is based on the decoding order of pictures is signaled in the NNPFC SEI message, and wherein one or more of the following apply: one particular value of the indication indicates that all pictures in the input of the NNPF when applied for any current picture are before the current picture in the decoding order. This enables that the NNPF can be applied while decoding the pictures in real time; one particular value of the indication indicates that, the input signal in the specific picture before the current picture in the decoding picture order shall be used; one particular value of the indication indicates that, the input signal in the specific picture before the current picture in the decoding picture order shall not be used; one particular value of the indication indicates that, the input signal in the specific picture after the current picture in the decoding picture order shall be used; one particular value of the indication indicates that, the input signal in the specific picture after the current picture in the decoding picture order shall not be used; one particular value of the indication indicates that, the input signal in the specific picture before the current picture in the output picture order shall be used; one particular value of the indication indicates that, the input signal in the specific picture before the current picture in the output picture order shall not be used; one particular value of the indication indicates that, the input signal in the specific picture after the current picture in the output picture order shall be used; and one particular value of the indication indicates that, the input signal in the specific picture after the current picture in the output picture order shall be NOT used.
18. The method of any of solutions 1-17, wherein a message is signaled to indicate whether an input picture to the NNPF shall be the picture before or after a process.
19. The method of any of solutions 1-18, wherein the input picture is the current picture or a reference picture, wherein the message is a SEI message, or wherein the process is a filtering process.
20. The method of any of solutions 1-19, wherein usage of the method depends on coding information.
21. The method of any of solutions 1-20, wherein usage of the method depends on a SEI message.
22. An apparatus for processing video data comprising: a processor; and a non-transitory memory with instructions thereon, wherein the instructions upon execution by the processor, cause the processor to perform the method of any of solutions 1-21.
23. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-21.
24. A non-transitory computer-readable recording medium storing a bitstream of a video which is generated by a method performed by a video processing apparatus, wherein the method comprises: determining when an input of a neural-network post-filter (NNPF) activated for a current picture includes the current picture, the current picture used in the input is the current picture before applying the NNPF; and generating a bitstream based on the determining.
25. A method for storing bitstream of a video comprising: determining when an input of a neural-network post-filter (NNPF) activated for a current picture includes the current picture, the current picture used in the input is the current picture before applying the NNPF; generating a bitstream based on the determining; and storing the bitstream in a non-transitory computer-readable recording medium.
26. A method, apparatus, or system described in the present document.

The following solutions show further examples of techniques discussed herein.
1. A method for processing media data comprising: determining when an input of a neural-network post-filter (NNPF) activated for a current picture includes the current picture, the current picture used in the input is the current picture before applying the NNPF; and performing a conversion between a visual media data and a bitstream based on the NNPF.
2. The method of solution 1, wherein when the input of the NNPF activated for the current picture includes a picture (picX) that is not the current picture, one or more of the following apply: when picX precedes the current picture in output order, picX used in the input shall be the picX after applying the NNPF; when picX follows the current picture in output order, picX used in the input shall be picX before applying the NNPF; when picture picX precedes the current picture in decoding order, picX used in the input shall be picX after applying the NNPF; when picX follows the current picture in decoding order, picX used in the input shall be picX before applying the NNPF; picX used in the input shall be the picX after applying the NNPF; and picX used in the input shall be pixX before applying the NNPF.
3. The method of any of solutions 1-2, wherein when multiple pictures are used as the input by an NNPF activated for the current picture one or more of the following aspects apply: when multiple pictures are used as the input by an NNPF activated for the current picture, all the input pictures preceding the current picture in output order shall be pictures after applying the NNPF, and all the input pictures following the current picture in output order shall be pictures before applying the NNPF; when multiple pictures are used as the input by an NNPF activated for the current picture, all the input pictures preceding the current picture in decoding order shall be pictures after applying the NNPF, and all the input pictures following the current picture in decoding order shall be pictures before applying the NNPF; when multiple pictures are used as the input by an NNPF activated for the current picture, all the input pictures excluding the current picture itself shall be pictures before applying the NNPF; and when multiple pictures are used as the input by an NNPF activated for the current picture, all the input pictures excluding the current picture itself shall be pictures after applying the NNPF.
4. The method of any of solutions 1-3, wherein multiple input pictures are signaled for an NNPF in the neural-network post-filter characteristics (NNPFC) supplemental enhancement information (SEI) message, an indication indicating a use of pictures before or after applying the NNPF is signaled in the NNPFC SEI message or in a neural-network post-filter activation (NNPFA) SEI message, and wherein when multiple pictures are used as the input by an NNPF activated for the current picture, one or more of the following aspects apply: one particular value of the indication indicates that, when multiple pictures are used as the input by an NNPF activated for a particular current picture, all the input pictures preceding the current picture in output order shall be pictures after applying the NNPF, and all the input pictures following the current picture in output order shall be pictures before applying the NNPF; one particular value of the indication indicates that, when multiple pictures are used as the input by an NNPF activated for a particular current picture, all the input pictures preceding the current picture in decoding order shall be pictures after applying the NNPF, and all the input pictures following the current picture in decoding order shall be pictures before applying the NNPF; one particular value of the indication indicates that, when multiple pictures are used as the input by an NNPF activated for a particular current picture, all the input pictures excluding the current picture itself shall be pictures before applying the NNPF; and one particular value of the indication indicates that, when multiple pictures are used as the input by an NNPF activated for a particular current picture, all the input pictures excluding the current picture itself shall be pictures after applying the NNPF.
5. The method of any of solutions 1-4, wherein when two or more NNPFs, including a first NNPF (NNPFa) and a second NNPF (NNPFb), are activated for the current picture, and an indication indicated that NNPFb is applied immediately after applying NNPFa; one or more of the following apply: when the input of NNPFb includes the current picture, the current picture after applying NNPFa and before applying NNPFb shall be used; when the input of NNPFb includes a picture picX preceding the current picture in output order, the picture picX after applying NNPFa and after applying NNPFb shall be used; when the input of NNPFb includes a picture picX preceding the current picture in output order, the picture picX after applying NNPFa and before applying NNPFb shall be used; when the input of NNPFb includes a picture picX preceding the current picture in output order, the picture picX before applying NNPFa and before applying NNPFb shall be used; when the input of NNPFb includes a picture picX following the current picture in output order, the picture picX before applying NNPFa and before applying NNPFb shall be used; when the input of NNPFb includes a picture picX following the current picture in output order, the picture picX after applying NNPFa and before applying NNPFb shall be used; when the input of NNPFb includes a picture picX following the current picture in output order, the picture picX after applying NNPFa and after applying NNPFb shall be used; when the input of NNPFb includes a picture picX preceding the current picture in decoding order, the picture picX after applying NNPFa and after applying NNPFb shall be used; when the input of NNPFb includes a picture picX preceding the current picture in decoding order, the picture picX after applying NNPFa and before applying NNPFb shall be used; when the input of NNPFb includes a picture picX preceding the current picture in decoding order, the picture picX before applying NNPFa and before applying NNPFb shall be used; when the input of NNPFb includes a picture picX following the current picture in decoding order, the picture picX before applying NNPFa and before applying NNPFb shall be used; when the input of NNPFb includes a picture picX following the current picture in decoding order, the picture picX after applying NNPFa and before applying NNPFb shall be used; when the input of NNPFb includes a picture picX following the current picture in decoding order, the picture picX after applying NNPFa and after applying NNPFb shall be used; when the input of NNPFb includes a picture picX that is not the current picture, the picture picX after applying NNPFa and after applying NNPFb shall be used; when the input of NNPFb includes a picture picX that is not the current picture, the picture picX after applying NNPFa and before applying NNPFb shall be used; when the input of NNPFb includes a picture picX that is not the current picture, the picture picX before applying NNPFa and before applying NNPFb shall be used; and when the purpose of NNPFa is related to resampling, and the input of NNPFb includes the current picture, the current picture after applying NNPFa and before applying NNPFb shall be used, wherein the resampling includes upsampling or downsampling for frame rate, bitdepth, resolution, or chroma format.
6. The method of any of solutions 1-5, wherein an indication indicating a use of pictures before or after applying an NNPF is signaled in the NNPFC SEI message or in the NNPFA SEI message, and wherein when two or more NNPFs, including NNPFb and NNPFa, are activated for the current picture, and an indicator indicates that NNPFb is applied immediately after applying NNPFa, one or more of the following apply: when the input of NNPFb includes the current picture, the current picture after applying NNPFa and before applying NNPFb shall be used; when the input of NNPFb includes multiple current pictures, the current picture after applying NNPFa and before applying NNPFb together with the current picture before applying NNPFa shall be used; one particular value of the indication indicates that, when the input of NNPFb includes a picture picX preceding the current picture in output order, the picture picX after applying NNPFa and after applying NNPFb shall be used; one particular value of the indication indicates that when the input of NNPFb includes a picture picX preceding the current picture in output order, the picture picX before applying NNPFa and before applying NNPFb shall be used; one particular value of the indication indicates that when the input of NNPFb includes a picture picX preceding the current picture in output order, the picture picX before applying NNPFa and before applying NNPFb shall be used; one particular value of the indication indicates that when the input of NNPFb includes a picture picX following the current picture in output order, the picture picX before applying NNPFa and before applying NNPFb shall be used; one particular value of the indication indicates that when the input of NNPFb includes a picture picX following the current picture in output order, the picture picX after applying NNPFa and before applying NNPFb shall be used; one particular value of the indication indicates that when the input of NNPFb includes a picture picX following the current picture in output order, the picture picX after applying NNPFa and after applying NNPFb shall be used; one particular value of the indication indicates that when the input of NNPFb includes a picture picX preceding the current picture in decoding order, the picture picX after applying NNPFa and after applying NNPFb shall be used; one particular value of the indication indicates that when the input of NNPFb includes a picture picX preceding the current picture in decoding order, the picture picX after applying NNPFa and before applying NNPFb shall be used; one particular value of the indication indicates that when the input of NNPFb includes a picture picX preceding the current picture in decoding order, the picture picX before applying NNPFa and before applying NNPFb shall be used; one particular value of the indication indicates that when the input of NNPFb includes a picture picX following the current picture in decoding order, the picture picX before applying NNPFa and before applying NNPFb shall be used; one particular value of the indication indicates that when the input of NNPFb includes a picture picX following the current picture in decoding order, the picture picX after applying NNPFa and before applying NNPFb shall be used; one particular value of the indication indicates that when the input of NNPFb includes a picture picX following the current picture in decoding order, the picture picX after applying NNPFa and after applying NNPFb shall be used; one particular value of the indication indicates that when the input of NNPFb includes a picture picX that is not the current picture, the picture picX after applying NNPFa and after applying NNPFb shall be used; one particular value of the indication indicates that when the input of NNPFb includes a picture picX that is not the current picture, the picture picX after applying NNPFa and before applying NNPFb shall be used; one particular value of the indication indicates that when the input of NNPFb includes a picture picX that is not the current picture, the picture picX before applying NNPFa and before applying NNPFb shall be used; the indication is not signaled when the purpose of NNPFa is related to resampling; and the indication can be signaled when the purpose of NNPFa is related to quality enhancement, wherein one of the preceding is used as a default when an indication is not signaled, and wherein the resampling includes upsampling or downsampling for frame rate, bitdepth, resolution, or chroma format.
7. The method of any of solutions 1-6, wherein a first indication (idcA) and a second indication (idcB) are signalled in the NNPFC SEI message or in the NNPFA SEI message, wherein idcB indicates the use of pictures before or after applying a current NNPF, wherein idcA indicates a use of pictures before or after applying another NNPF that is to be immediately applied before applying the current NNPF, and wherein when two or more NNPFs, including the NNPFb and NNPFa, are activated for the current picture, and when an indicator indicates that NNPFb is applied immediately after applying NNPFa, one or more of the following apply: when the input of NNPFb includes the current picture, the current picture after applying NNPFa and before applying NNPFb shall be used; one particular value of idcA indicates that, when the input of NNPFb includes a picture picX preceding the current picture in output order, the picture picX used in the input shall be after applying NNPFa, and whether it shall be before or after applying NNPFb is determined by the value of idcB; one particular value of idcA indicates that, when the input of NNPFb includes a picture picX preceding the current picture in output order, the picture picX used in the input shall be before applying NNPFa, and whether it shall be before or after applying NNPFb is determined by the value of idcB; one particular value of idcA indicates that, when the input of NNPFb includes a picture picX following the current picture in output order, the picture picX used in the input shall be after applying NNPFa, and whether it shall be before or after applying NNPFb is determined by the value of idcB; one particular value of idcA indicates that, when the input of NNPFb includes a picture picX following the current picture in output order, the picture picX used in the input shall be before applying NNPFa, and whether it shall be before or after applying NNPFb is determined by the value of idcB; one particular value of idcA indicates that, when the input of NNPFb includes a picture picX preceding the current picture in decoding order, the picture picX used in the input shall be after applying NNPFa, and whether it shall be before or after applying NNPFb is determined by the value of idcB; one particular value of idcA indicates that, when the input of NNPFb includes a picture picX preceding the current picture in decoding order, the picture picX used in the input shall be before applying NNPFa, and whether it shall be before or after applying NNPFb is determined by the value of idcB; one particular value of idcA indicates that, when the input of NNPFb includes a picture picX following the current picture in decoding order, the picture picX used in the input shall be after applying NNPFa, and whether it shall be before or after applying NNPFb is determined by the value of idcB; one particular value of idcA indicates that, when the input of NNPFb includes a picture picX following the current picture in decoding order, the picture picX used in the input shall be before applying NNPFa, and whether it shall be before or after applying NNPFb is determined by the value of idcB; one particular value of idcA indicates that, when the input of NNPFb includes a picture picX that is not the current picture, the picture picX used in the input shall be after applying NNPFa, and whether it shall be before or after applying NNPFb is determined by the value of idcB; and one particular value of idcA indicates that, when the input of NNPFb includes a picture picX that is not the current picture, the picture picX used in the input shall be before applying NNPFa, and whether it shall be before or after applying NNPFb is determined by the value of idcB.
8. The method of any of solutions 1-7, wherein a NNPFC identifier (nnpfc_id) contains an identifying number used to identify a post-processing filter and also indicates a preferred order of processing of a post-processing filter.
9. The method of any of solutions 1-8, wherein when multiple NNPFC SEI messages are present, a value of nnpfc_id in a current NNPFC SEI message less than the value of nnpfc_id in another NNPFC SEI message indicates the post-processing filter specified in the current NNPFC SEI message, when activated by an NNPFA SEI message, should be processed before the post-processing filter specified in the another NNPFC SEI message, when activated by an NNPFA SEI message.
10. The method of any of solutions 1-9, wherein the NNPFC SEI message includes a flag to indicate whether different values of nnpfc_id for different NNPFs also indicate preferred processing order of the different NNPFs.
11. The method of any of solutions 1-10, wherein when a nnpfc_id_also_indicates_processing_order_flag is equal to 1, nnpfc_id contains an identifying number used to identify a post-processing filter and also indicates a preferred order of processing of a post-processing filter
12. The method of any of solutions 1-11, wherein when multiple NNPFC SEI messages are present, a value of nnpfc_id in a current NNPFC SEI message less than the value of nnpfc_id in another NNPFC SEI message indicates the post-processing filter specified in the current NNPFC SEI message, when activated by an NNPFA SEI message, should be processed before the post-processing filter specified in the another NNPFC SEI message, when activated by an NNPFA SEI message.
13. The method of any of solutions 1-12, wherein when a nnpfc_id_also_indicates_processing_order_flag is equal to 0, nnpfc_id contains an identifying number that identifies a post-processing filter, but does not indicates a preferred order of processing of a post-processing filter.
14. The method of any solutions 1-13, wherein when a nnpfc_id_also_indicates_processing_order_flag is equal to 0, a preferred order of processing of a post-processing filter is unknown.
15. The method of any of solutions 1-14, wherein when a nnpfc_id_also_indicates_processing_order_flag is equal to 0 for two NNPFs, there is no preferred order of processing of the two NNPFs.
16. The method of any of solutions 1-15, wherein an order of applying the NNPFs for a specific picture follows an activation order indicated by corresponding NNPFA messages.
17. The method of any of solutions 1-16, wherein an order of applying NNPFs for a specific picture is in reverse order of an activation order indicated by corresponding NNPFA messages.
18. The method of any of solutions 1-17, wherein an indication indicating whether applying NNPFC for any current picture is based on the decoding order of pictures is signaled in the NNPFC SEI message, and wherein one or more of the following apply: one particular value of the indication indicates that all pictures in the input of the NNPF when applied for any current picture are before the current picture in the decoding order, which enables the NNPF to be applied while decoding the pictures in real time; one particular value of the indication indicates that the input signal in a specific picture before the current picture in the decoding picture order shall be used; one particular value of the indication indicates that the input signal in the specific picture before the current picture in the decoding picture order shall not be used; one particular value of the indication indicates that the input signal in the specific picture after the current picture in the decoding picture order shall be used; one particular value of the indication indicates that the input signal in the specific picture after the current picture in the decoding picture order shall not be used; one particular value of the indication indicates that the input signal in the specific picture before the current picture in the output picture order shall be used; one particular value of the indication indicates that the input signal in the specific picture before the current picture in the output picture order shall not be used; one particular value of the indication indicates that the input signal in the specific picture after the current picture in the output picture order shall be used; and one particular value of the indication indicates that the input signal in the specific picture after the current picture in the output picture order shall not be used.
19. The method of any of solutions 1-18, wherein a message is signaled to indicate whether an input picture to the NNPF shall be the picture before or after a process.
20. The method of any of solutions 1-19, wherein the input picture is the current picture or a reference picture, wherein the message is a SEI message including a NNPFC SEI message or a NNPFA SEI message, or wherein the process is a filtering process including Adaptive Loop Filter (ALF), Cross Component ALF (CC-ALF), Bilateral filter (BIF), Chroma-BIF, Sample Adaptive Offset (SAO), deblocking, or any combination thereof.
21. The method of any of solutions 1-20, wherein before or after applying an NNPF includes before or after applying a process, and wherein the process includes ALF, BIF, SAO, deblocking, or any combination thereof.
22. The method of any of solutions 1-21, wherein usage of the method depends on coding information including color format, color component, resolution, Quantization Parameter (QP), temporal layer, Picture Order Count (POC).
23. The method of any of solutions 1-22, wherein usage of the method depends on a SEI message not including a NNPFC SEI message or a NNPFA SEI message.
24. The method of any of solutions 1-23, wherein the conversion includes encoding the visual media data into the bitstream.
25. The method of any of solutions 1-23, wherein the conversion includes decoding the visual media data from the bitstream.
26. An apparatus for processing video data comprising: a processor; and a non-transitory memory with instructions thereon, wherein the instructions upon execution by the processor, cause the processor to perform the method of any of solutions 1-25.
27. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-25.
28. A non-transitory computer-readable recording medium storing a bitstream of a video which is generated by a method performed by a video processing apparatus, wherein the method comprises: determining when an input of a neural-network post-filter (NNPF) activated for a current picture includes the current picture, the current picture used in the input is the current picture before applying the NNPF; and generating a bitstream based on the determining.
29. A method for storing bitstream of a video comprising: determining when an input of a neural-network post-filter (NNPF) activated for a current picture includes the current picture, the current picture used in the input is the current picture before applying the NNPF; generating a bitstream based on the determining; and storing the bitstream in a non-transitory computer-readable recording medium.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present document, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing visual media data, comprising:
performing a conversion between visual media data and a bitstream of the visual media data based on a rule,
wherein the rule specifies that, in response to a first neural-network post-filter (NNPF) being activated for a current picture, an input picture for the first NNPF is a picture before applying the first NNPF.

2. The method of claim 1, wherein the input picture for the first NNPF includes the current picture.

3. The method of claim 1, wherein the input picture for the first NNPF includes one or more pictures that are not the current picture.

4. The method of claim 1, wherein the rule further specifies that, in response to a second NNPF further being activated for the current picture, when the first NNPF and the second NNPF are applied in an order that the first NNPF is applied before the second NNPF, an input picture for the second NNPF is a picture after applying the first NNPF and before applying the second NNPF.

5. The method of claim 4, wherein the input picture for the second NNPF includes the current picture.

6. The method of claim 4, wherein the input picture for the second NNPF includes one or more pictures that are not the current picture.

7. The method of claim 6, wherein the input picture for the second NNPF includes a picture preceding the current picture in an output order.

8. The method of claim 6, wherein the input picture for the second NNPF includes a picture following the current picture in an output order.

9. The method of claim 1, wherein the conversion includes encoding the visual media data into the bitstream.

10. The method of claim 1, wherein the conversion includes decoding the visual media data from the bitstream.

11. An apparatus for processing visual media data comprising: a processor and a non-transitory memory with instructions thereon, wherein the instructions upon execution by the processor, cause the processor to:
perform a conversion between visual media data and a bitstream of the visual media data based on a rule,
wherein the rule specifies that, in response to a first neural-network post-filter (NNPF) being activated for a current picture, an input picture for the first NNPF is a picture before applying the first NNPF.

12. The apparatus of claim 11, wherein the input picture for the first NNPF includes the current picture, and/or
wherein the input picture for the first NNPF includes one or more pictures that are not the current picture.

13. The apparatus of claim 11, wherein the rule further specifies that, in response to a second NNPF further being activated for the current picture, when the first NNPF and the second NNPF are applied in an order that the first NNPF is applied before the second NNPF, an input picture for the second NNPF is a picture after applying the first NNPF and before applying the second NNPF.

14. The apparatus of claim 13, wherein the input picture for the second NNPF includes the current picture, and/or
wherein the input picture for the second NNPF includes one or more pictures that are not the current picture.

15. A non-transitory computer-readable storage medium storing instructions that cause a processor to:
perform a conversion between visual media data and a bitstream of the visual media data based on a rule,
wherein the rule specifies that, in response to a first neural-network post-filter (NNPF) being activated for a current picture, an input picture for the first NNPF is a picture before applying the first NNPF.

16. The non-transitory computer-readable storage medium of claim 15, wherein the input picture for the first NNPF includes the current picture, and/or
wherein the input picture for the first NNPF includes one or more pictures that are not the current picture.

17. The non-transitory computer-readable storage medium of claim 15, wherein the rule further specifies that, in response to a second NNPF further being activated for the current picture, when the first NNPF and the second NNPF are applied in an order that the first NNPF is applied before the second NNPF, an input picture for the second NNPF is a picture after applying the first NNPF and before applying the second NNPF.

18. A non-transitory computer-readable recording medium storing a bitstream of visual media data which is generated by a method performed by a visual media data processing apparatus, wherein the method comprises:
generating the bitstream based on a rule,
wherein the rule specifies that, in response to a first neural-network post-filter (NNPF) being activated for a current picture, an input picture for the first NNPF is a picture before applying the first NNPF.

19. The non-transitory computer-readable recording medium of claim 18, wherein the input picture for the first NNPF includes the current picture, and/or
wherein the input picture for the first NNPF includes one or more pictures that are not the current picture.

20. The non-transitory computer-readable recording medium of claim 18, wherein the rule further specifies that, in response to a second NNPF further being activated for the current picture, when the first NNPF and the second NNPF are applied in an order that the first NNPF is applied before the second NNPF, an input picture for the second NNPF is a picture after applying the first NNPF and before applying the second NNPF.
